(19) United States
(12) Patent Application Publication
(10) Pub. No.: US 2026/0326170 A1
(43) Pub. Date: Oct. 22, 2026

(54) SYSTEM AND METHOD FOR PFAS CONTAINMENT

(71) Applicant: BASF SE, Ludwigshafen am Rhein (DE)

(72) Inventor: Charles L. Tazzia, Wyandotte, MI (US)

(73) Assignee: BASF SE, Ludwigshafen am Rhein (DE)

(21) Appl. No.: 19/111,359

(22) PCT Filed: Sep. 19, 2023
(86) PCT No.: PCT/US2023/074598

§ 371 Date: Mar. 13, 2025

Related U.S. Application Data
(60) Provisional application No. 63/408,232, filed on Sep. 20, 2022.

(30) Foreign Application Priority Data
Dec. 14, 2022 (EP) 22213316.7

(51) Int. Cl. B09B 3/25; B09B 3/40; B09B 101/75

(52) U.S. Cl. CPC B09B 3/25; B09B 3/40; B09B 2101/75

(57) ABSTRACT

In a system for containment of per- and polyfluoroalkyl substances (PFAS), the system includes a substrate having at least one surface and barrier enclosing the at least one surface of the substrate. The barrier includes a polyurea polymer formed as a reaction product of an isocyanate, a polyol, an amine, a chain extender and at least one additive. The barrier having the polyurea polymer enclosing the at least one surface restricts movement of the PFAS.

### FIELD OF INVENTION

The present invention relates to a system for containment of per- and polyfluoroalkyl substances (PFAS), a method for containment of PFAS, and uses thereof.

### BACKGROUND OF THE INVENTION

Per- and polyfluoroalkyl substances (PFAS) are being used for a wide variety of applications, including as a fire extinguishing agent at military bases, airports, chemical facilities, etc. Usage of PFAS cause the exposed areas as well as adjoining areas to become contaminated with PFAS. On substrates like concrete pavement or concrete water/sewer pipes, exposure to water through precipitation causes PFAS contaminants to leach out into surface waters that further contaminates nearby surfaces and ground water, and ultimately drinking water. The class of chemicals categorised as PFAS are known to cause serious health effects (e.g. various cancers) at extremely low levels. Various physical barriers and containment systems have been studied for general containment of PFAS including concrete enclosures, metallic or composite material based tanks/containers with or without enclosing barrier materials. Concrete is prone to leaching as mentioned above and requires better barrier materials.

Physical and chemical properties of the barrier materials can make them undesirable for containment, such as high film thickness, high VOC values, longer drying time/curing time, unsuitable shore hardness and tensile strength. When containment systems are to be deployed for containing PFAS contaminants, there is a need for the barrier materials to have better physical and application properties. Properties of some barrier materials have been observed. Acrylic, Alkyd and cement material as barrier materials show higher dry times and higher VOC value as listed below.

| Product | [Manufacturer] \| | | Film | | | VOC |
|---|---|---|---|---|---|---|
| Name | Description | Chemistry | Thickness | | Dry time | (g/L) |
| Granite Grip | [BEHR (Masco)] \| | Acrylic | 11 and 16 | | 1 hr to | NA |
| Concrete | interior/exterior decorative | | mils dry | | touch, 3- | |
| Coating | floor coating | | | | 4 hrs to | |
| | | | | | recoat | |
| WATER | [Olympic (PPG)] \| Multi | Acrylic | NA | | 12 to 24 | 87-148 |
| GUARD | surface waterproofing | | | | hrs | g/L |
| | clear sealant | | | | | |
| 4902 Yellow | [RAE] \| Longer drying | Acrylic | 7 | mil | 85 | 35-68 |
| Acrylic | parking lot and zone | latex | | | minutes | g/L |
| Latex | marking paint | | | | final | |
| | Traffic Marking Paint | | | | | |
| 7300 Yellow | [RAE] \| Heavy duty | Alkyd | 7.5 | mil | 10 mins | 87-148 |
| Alkyd Low | Traffic Marking Paint, | | | | walk, 40 | g/L |
| VOC | (solvent based) | | | | mins full | |
| Concentrate | [XYPEX] \| Cementaceous | cementitious | 1 | mm | 48 hrs | 0 |

| | | | | |
|---|---|---|---|---|
| 071616 | concrete modifier. | slurry | initial | g/L |
| Cementitious | Mixed with concrete to | | | |
| Crystalline | create finishing barrier | | | |
| | layer. Adhesion 1.23 | | | |
| | Mpa - EN 1542 | | | |

Epoxy materials too as barrier show significant film thickness, higher dry times, higher VOC values, unsuitable hardness and tensile strength as listed below.

| | [Manufacturer] \| | | | | | |
|---|---|---|---|---|---|---|
| | Description \| | | | | | |
| Product | Additional | Film | Dry | | Tensile | VOC |
| Name | properties (If any) | Thickness | time | Hardness | Strength | (g/L) |
| KL5000/ | [PPG] \| Epoxy floor | 35-50 | 24 hrs | NA | NA | 85 g/L |
| 5000B | coating | mils | to walk, | | | |
| | | | 72 hr | | | |
| | | | final | | | |
| Self- | [PPG] \| Epoxy floor | 10-30 | 8 hr to | 75 | 9500 psi | NA |
| Levelling | coating \| Flexural | mils | touch, 7 | Shore | | |
| Epoxy Floor | Strength - 12800 | | day full | D | | |
| Coating | psi | | | | | |
| DC215 | [Epic Coatings] \| | 10-30 | 3.5 hrs | 70 | 5,800 psi, | 2 g/L |
| High Build | fast-curing, high- | mils | tack | Shore | ULTIMATE | |
| Epoxy | build epoxy with | | free, 2- | D | ELONGATION: | |
| | high impact and | | 5 days | | 3.2% | |
| | chemical resistance | | full | | ASTM | |
| | \| Abrasion | | | | D638 | |
| | Resistance (Taber) - | | | | | |
| | 26 mg loss CS-17 | | | | | |
| | wheel, with 1000 | | | | | |
| | gram load, 500 | | | | | |
| | cycles, Adhesion - | | | | | |
| | 440 psi @ elcometer | | | | | |
| | (concrete failure), | | | | | |
| | Compressive | | | | | |
| | Strength -10,000 | | | | | |
| | psi ASTM D695, | | | | | |
| | Flexural Strength - | | | | | |
| | 7,400 psi ASTM | | | | | |
| | D790 | | | | | |
| CarboGuard | [Carboline] \| | 125 | 8 hr | Shore | 1300 PSI | 0 g/L |
| 501 | Chemical resistant | mils | topcoat, | D 60 | ASTM | (calculated) |
| | epoxy patching and | per coat | 7 days | | C307 | |
| | surfacing compound, | | full | | | |
| | Adhesion - >400 | | | | | |
| | PSI concrete failure, | | | | | |
| | ASTM D4541 | | | | | |
| | (elcometer), | | | | | |
| | Compressive Strength - | | | | | |
| | 5000 PSI (ASTM | | | | | |
| | C579), Flexural | | | | | |
| | Strength - 2200 PSI | | | | | |
| | ASTM C580 | | | | | |
| Interline | [Akzo Nobel] \| | 12-56 | 6 hr | | 5076 PSI | 0.58 lb/gal, |
| 984 | Epoxy phenolic\| | mils | touch, | | | 38 g/kg |
| | Two component, | | 12 | | | |
| | solvent free | | hours | | | |
| | chemically resistant | | hard | | | |
| | tank lining system. | | dry | | | |
| | Abrasion | | | | | |
| | Resistance (Taber) | | | | | |
| | 179 mg (CS17, | | | | | |
| | 1000 g, 1000 rev) | | | | | |
| MasterTop | [Master Builders] \| | 30-40 | 4 hrs | Shore | psi (MPa) | |
| 1217CR | Novolac epoxy \| | mils | tack | D 80 | 5,700 | |
| | Premium chemical | | free, 7 | | (39.58), | |
| | Resistant coating | | days | | elongation, | |
| | for harsh industrial | | final | | %3.7 | |
| | environments, | | | | ASTM | |
| | Compressive | | | | D638 | |
| | Strength - psi | | | | | |
| | (MPa) 14,300 | | | | | |
| | (99.3) ASTM D695 | | | | | |

Vinyl ester based materials too as barrier show significant film thickness, longer dry times, higher VOC values, and tensile strength, low abrasion resistance as listed below.

| | | | | | | H2O | Abrasion |
|---|---|---|---|---|---|---|---|
| Product | [Manufacturer] \| | Film | Dry | Tensile | VOC | Vapor | Resistance |
| Name | Description | Thickness | time | Strength | (g/L) | Transmission | (Taber) |
| STONCHEM | [Stonhard] \| Silica- | 40 mil | 1 hr | 3000 | 800/820 | | 0.1 g |
| 882 | free, spark- | | tack | PSI | Liquids | | max, |
| | proof, acid and | | free, | ASTM | 53 g/L, | | CS17 |
| | oxidizer resistant | | 7 | D 638 | 800 SF | | wheel |
| | vinyl ester lining | | days | | Topcoat | | |
| | system, Shore D | | full | | 83 g/L | | |
| | Hardness: 85-90, | | | | (ASTM | | |
| | Flexural Strength | | | | D2369, | | |
| | 12000 PSI ASTM | | | | E) | | |
| | C580 | | | | | | |
| International | [Akzo Nobel] \| | 125 | 24 hr | | NA | 0.0135 | 70-100 |
| CEILCOTE | Vinyl ester lining/ | mils + | to | | | @ 125 | mg |
| 6640 | topping Fibreglass | fill | service | | | mils | (CS17F, |
| Ceilcrete | or synthetic cloth/ | | | | | | 1000 g, |
| | mat reinforced; | | | | | | 5000 |
| | trowel applied | | | | | | rev.) |
| | system | | | | | | |
| International | [Akzo Nobel] \| | 30-40 | 24 hr | 2500- | 257 g/L | 0.0016 | 78 mg |
| CEILCOTE | flake filled | mils | to | 3000 | | per m | (CS17, |
| 242 | Primer + topcoat | | service | psi | | inch | 1000 g, |
| Flakeline | system, Compressive | | | | | | 1000 |
| | Strength - 12000 | | | | | | rev) |

Latex, Methyl methacrylate resin, Polyaspartic, Rubber based, and Urethane materials too as barrier show significant film thickness, longer dry times, higher VOC values, unsuitable tensile strength as listed below.

| Product | [Manufacturer] \| | | Film | Dry | Tensile | VOC |
|---|---|---|---|---|---|---|
| Name | Description | Chemistry | Thickness | time | Strength | (g/L) |
| DRY- | [UGL (CIMIC)] \| Basement | Latex | 2 coats | 3 hrs | | 100 |
| LOCK | and masonry water | | 13 mil | | | g/L |
| Original | proofer \| Performance | | wet | | | |
| | Notes: Apply 2 coats min | | | | | |
| Master- | [Master Builders] \| Multi- | Methyl | NA | 1 hr | psi | 0 |
| Top | purpose, flexible MMA | methacrylate | | full | (MPa) | g/L |
| SRS | resin for use as a primer, | resin | | cure | 1,350 | |
| 40TC | overlay or topcoat. \| | | | | (9.3), | |
| | Hardness: Shore D 61 | | | | 140% | |
| | | | | | elongation | |
| | | | | | at break | |
| | | | | | ASTM | |
| | | | | | D638 | |
| Master- | [Master Builders] \| Aliphatic | Polyaspartic | NA | 2 hrs | 6200 | <100 |
| Top | coating for abrasion | | | walk, | PSI, | g/L |
| TC693 | resistance, chemical | | | 4 days | Elongation: | |
| | resistance, weather resistance, | | | full | %14 | |
| | and colour retention \| | | | | ASTM | |
| | Abrasion Resistance | | | | 412 | |
| | (Taber): 45 mg loss (not | | | | | |
| | specified), Hardness 94 | | | | | |
| | (not specified), Adhesion | | | | | |
| | 350 PSI (not specified) | | | | | |
| Elasto- | [Daich Coatings] \| Roll-on | Rubber | 30-60 | 24 | Up to | <26 |
| lock | waterproofing membrane \| | based | mils | hrs | 549 p.s.i. | g/L |
| | Performance Notes: Not | | wet | | Elongation | |
| | UV stable, Adhesion: 2,600 | | | | Percentage - | |
| | (18) psi (MPa) 100% concrete | | | | 550 to | |
| | failure ASTM C 882 | | | | 820% | |
| | | | | | ASTM | |
| | | | | | D638 | |
| SHIELD | [Dyco] \| Water proofing | Urethane | NA | 20 | | 418 |
| & SEAL | sealer for epoxy bonded | | | mins | | g/L |
| 1380 | natural stone surfaces | | | to | | |
| Clear | | | | touch, | | |
| PUR | | | | 1 hr | | |
| Water- | | | | recoat | | |
| proofing | | | | | | |
| Sealer | | | | | | |

It was, therefore, an objective of the present invention to provide for a system for containment of PFAS such that the barrier used is associated with improved physical and application properties as well as shows improved containment of movement of PFAS contaminants from a PFAS contaminated substrate.

### SUMMARY OF THE INVENTION

Surprisingly, it has been found that the above identified objective problem is solved by the system for containment of per- and polyfluoroalkyl substances (PFAS), a method for containment of PFAS, and uses thereof according to this invention

Accordingly, in one aspect, the presently claimed invention is directed to a system for containment of per- and polyfluoroalkyl substances (PFAS), the system comprising:
a. a substrate having at least one surface;
b. a barrier enclosing the at least one surface of the substrate,
   wherein the barrier includes a polyurea polymer formed as a reaction product of at least one isocyanate, at least one polyol, at least one amine, at least one chain extender and at least one additive,
   wherein the barrier having the polyurea polymer enclosing the at least one surface restricts movement of the PFAS.

In another aspect, the presently claimed invention is directed to a method for containment of per- and polyfluoroalkyl substances (PFAS), the method comprising steps of at least:
a. providing the substrate with at least one surface;
b. enclosing the at least one surface of the substrate with the barrier with polyurea polymer;
c. optionally curing the polyurea polymer,
wherein the barrier having the polyurea polymer enclosing the at least one surface restricts movement of the PFAS.

In another aspect, the presently claimed invention is directed to the use of the containment system to restrict movement of PFAS in construction, containment of general contaminants, enclosing articles, preparation of bags, and preparation of containment units.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

An aspect of the present invention is directed to a system for containment of per- and polyfluoroalkyl substances (PFAS), the system comprising:
a. a substrate having at least one surface;
b. a barrier enclosing the at least one surface of the substrate,
wherein the barrier includes a polyurea polymer formed as a reaction product of at least one isocyanate, at least one polyol, at least one amine, at least one chain extender and at least one additive,
wherein the barrier having the polyurea polymer enclosing the at least one surface restricts movement of the PFAS.

### PFAS

The per- and polyfluoroalkyl substances (PFAS) are organofluroine compounds containing per fluro alkyl moiety, substances that contain at least one fully per fluorinated methyl group, or per fluorinated methylene group.

In a preferred embodiment, the PFAS includes 6:2 Fluorotelomer sulfonic acid (′6:2-FTS), Perfluoro heptanoic acid (PFHpA), perfluorohexanesulfonic acid (PFHxS), perfluorononanoic acid (PFNA), perfluorosulfonic acids such as perfluorooctanesulfonic acid (PFOS), perfluorocarboxylic acids (PFCAs) such as perfluorooctanoic acid (PFOA), short chain PFAS such as perfluorohexanoic acid (PFHxA) and perfluorobutanesulfonic acid (PFBS), perfluoroalkyl sulfonates (PFSAs), hexafluoropropylene oxide dimer acid and its ammonium salt (HFPO-DA), and Perfluorodecanoic acid (PFDA). In an embodiment, the PFAS includes Hexafluoropropylene oxide dimer acid (HFPO-DA), N-ethyl perfluorooctanesulfonamidoacetic acid (NEFOSAA), N-methyl perfluorooctanesulfonamidoacetic acid (NMeFOSAA), Perfluorobutanesulfonic acid (PFBS), Perfluorodecanoic acid (PFDA), Perfluorododecanoic acid (PFDoA), Perfluoroheptanoic acid (PFHpA), Perfluorohexanesulfonic acid (PFHxS), Perfluorohexanoic acid (PFHxA), Perfluorononanoic acid (PFNA), Perfluorooctanesulfonic acid (PFOS), Perfluorooctanoic acid (PFOA), Perfluorotetradecanoic acid (PFTA), Perfluorotridecanoic acid (PFTrDA), Perfluoroundecanoic acid (PFUnA), 11-chloroeicosafluoro-3-oxaundecane-1-sulfonic acid (11 Cl-PF3OUdS), 9-chlorohexadecafluoro-3-oxanone-1-sulfonic acid (9 Cl-PF3ONS), 4,8-dioxa-3H-perfluorononanoic acid (ADONA) as well as the ammonium, sodium and potassium salts thereof.

### Substrate

The substrate is defined by at least one surface.

In an embodiment, the substrate includes concrete, reinforced material, fabric, container, water tanks, conduit, pipe, cap cover, cap liner, aluminum, steel, blacktop, polyurethane foam, boat holds, geotextile fabrics, pipelines, decks, manholes, and fuel tanks, cylinder, uneven surface, soil/dirt, or fuel tanks.

In an embodiment the substrate is in shape of flat sheet, sphere, cuboidal, pipe, a cone, a trapezoid, cylinder, uneven surface, and soil/dirt.

### Surface of Substrate

In an embodiment, the at least one surface of the substrate completely or partially encloses a void or hollow space.

In a preferred embodiment, the substrate includes a completely covered hollow space such as but is not limited to a container, a tank, pipe-line, a conduit, and the like.

In another preferred embodiment, the substrate includes a partially covered hollow space such as but is not limited to a pipe, a pipe-line, a conduit, an open to air tank, a rain-water harvesting pit, a sheet, and the like.

In yet another preferred embodiment, void or hollow space of the substrate is uniformly filled with the material different from the at least one surface of the substrate such as, but is not limited to a multi-layered flat sheet, and the like.

In yet another embodiment, void or hollow space of the substrate is uniformly filled with the same material defining the at least one surface of the substrate, such as, but is not limited to a flat sheet, a concrete slab, and the like.

### Material of Subsrate

In an embodiment, the substrate and the at least one surface of the substrate is formed of same material. In a preferred embodiment, the at least one surface alone defines the substrate.

In another embodiment, the substrate and the at least one surface of the substrate is formed of different materials.

Materials include but is not limited to cement, concrete, resilient materials, fibres, glass material, wood, hard surface sheet, a metal, a plastic unit, a composite material, and the like. The materials are disclosed in an elaborate manner below:

### Composite Material

The composite material comprises thermoplastic composite, a polyamide, a co-polyamide, an aromatic polyamides, a thermoplastic polyurethane, a thermoset composite, or any combination thereof.

### Fibres

The fibres include non-woven fibers or fabric, woven fabrics, or non-crimp fabrics. The fibers include natural, synthetic or glass fibers. Synthetic fibers are for instance carbon fibers or polyester fibers. Natural fibers are for instance cellulosic bast fibers. The non-woven fibers may also contain a small amount of synthetic thermoplastic fiber, for instance polyethylene terephthalate fibers (PET). The fibers can be synthetic polyester fibers or other fibers or similar characteristics. Glass fibres include chopped glass fibres.

Although, any suitable binding agent can be used for binding the chopped glass fibers, preferred is an acrylic binder. The acrylic binder is a cured aqueous based acrylic resin. The binder cures, for instance, through carboxylic groups and a multi-functional alcohol.

In an embodiment, the fibres are bound by a binding agent. The binding agent includes acrylic binders. In embodiment, the resilient material is a layer formed of by sandwiching at least two sheets of hard material. Acrylic binders are polymers or copolymers containing units of acrylic acid, methacrylic acid, their esters, or related derivatives. The acrylic binders are for instance formed by aqueous emulsion polymerization employing (meth)acrylic acid (where the convention (meth)acrylic is intended to embrace both acrylic and methacrylic), 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, octadecyl(meth)acrylate, stearyl(meth)acrylate, tetrahydrofurfuryl(meth)acrylate, butoxyethyl(meth)acrylate, ethoxydiethylene glycol (meth)acrylate, benzyl(meth)acrylate, cyclohexyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethoxyethyl(meth)acrylate, methoxypolyethylene glycol (meth)acrylate, methoxypolypropylene glycol (meth)acrylate, dicyclopentadiene(meth)acrylate, dicyclopentanyl(meth)acrylate, tricyclodecanyl(meth)acrylate, isobornyl(meth)acrylate, bornyl(meth)acrylate or mixtures thereof.

Other monomers which can be co-polymerized with the (meth)acrylic monomers, generally in a minor amount, include styrene, diacetone(meth)acrylamide, isobutoxymethyl(meth)acrylamide, N-vinylpyrrolidone, N-vinylcaprolactam, N,N-dimethyl(meth)acrylamide, t-octyl(meth)acrylamide, N,N-diethyl(meth)acrylamide, N,N′-dimethyl-aminopropyl(meth)acrylamide, (meth)acryloylmorphorine; vinyl ethers such as hydroxybutyl vinyl ether, lauryl vinyl ether, cetyl vinyl ether, and 2-ethylhexyl vinyl ether; maleic acid esters; fumaric acid esters and similar compounds.

Multi-functional alcohols are for instance hydroquinone, 4,4′-dihydroxydiphenyl, 2,2-bis(4-hydroxyphenyl)propane, cresols or alkylene polyols containing 2 to 12 carbon atoms, including ethylene glycol, 1,2- or 1,3-propanediol, 1,2-, 1,3- or 1,4-butanediol, pentanediol, hexanediol, octanediol, dodecanediol, diethylene glycol, triethylene glycol, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol, tripentaerythritol and sorbitol.

In an embodiment, the substrate includes a fabric bag, a waste bag, a construction material enclosing fabric.

### Concrete

In an embodiment, the substrate is a concrete unit to form an enclosure, wall, pavement, containment unit that include structures above ground, partially or completely underground, partially or completely submerged in water. Concrete unit includes a concrete housing unit.

### Reinforced Material

In another embodiment, the substrate includes a reinforced material used to form an enclosure, wall, pavement, containment unit that include structures above ground, partially or completely underground, partially or completely submerged in water. Reinforced material include concrete reinforced with metal, fibre reinforced glass, metal reinforced plastic, a composite rebar, and the like.

### Metal

In another embodiment, the substrate includes a metal used to form an enclosure, wall, pavement, containment unit that include structures above ground, partially or completely underground, partially or completely submerged in water. Metal includes elemental metals and metallic compounds. The metals include aluminium, iron, steel, etc. In a preferred embodiment, the substrate includes metal containers.

In another embodiment, the substrate includes containers for storage of water, fuels, other fluids, grains, soil, food, gases, solid substances. The containers include containers above ground, partially or completely underground, partially or completely submerged in water. The substrate includes water storage units, fuel storage units, grain storage units, and the like.

### Other Substrates

In another embodiment, the substrate includes pipes, cap covers, cap liners, sheets,

In another embodiment, the substrate includes pipes for conveying water, fuel, and other liquids/fluids.

In another embodiment, the substrate includes cap cover and cap liner.

In another embodiment, the substrate includes sheets. In a preferred embodiment, the sheet is used to separate one soil layer from another soil layer. In a more preferred embodiment, the substrate is a protective sheet that separates a top-soil layer from bottom contaminated layer of soil with a PFAS contaminants for performing farming/agriculture, to grow crops, plant trees and the like.

In another embodiment, other types of the substrate further includes blacktop, polyurethane foam, boat holds, geotextile fabrics, decks, manholes, pipelines and fuel tanks.

### Coating on Substrate

In an embodiment, the substrate is defined to include a coating on the surface of the substrate.

In a preferred embodiment, the coating on the surface of the substrate is formed of epoxy material.

In a more preferred embodiment, substrate is coated with an epoxy coating while the barrier with the polyurea polymer is coated on top of the epoxy coating.

In a further more preferred embodiment, the epoxy coating is provided over a concrete substrate, a fabric, a waste bag, a tank and the like.

The system for containment of PFAS with an epoxy coating between the substrate and the barrier having the polyurea polymer coating has the advantage that adhesion of the poly urea coating to the substrate, respectively to the epoxy coating is increased.

In an embodiment, the substrate is uncontaminated by any PFAS contaminant or is contaminated with at least one PFAS contaminant.

### Uncontaminated Substrate

The uncontaminated substrate is the substrate that is not exposed to any PFAS contaminant, such that no PFAS contaminant is present on the at least one surface of the substrate or within the void or filled up material of the substrate. In a preferred embodiment, the uncontaminated substrate includes a water tank, a fuel tank, a food storage container, a liquid storage unit, a drinking water tank, a cap cover, a soil cover, a rain-water harvesting unit, a roof top, a brick wall, a wall unit, a soak pit, a drainage pit, a concrete slab, pavement and the like.

### Contaminated Substrate

The contaminated substrate is the substrate that is exposed or subjected or treated with at least one PFAS contaminant such that at least one PFAS contaminant is present, embedded, mixed, interlocked on the at least one surface of the substrate or within the void or filled up material of the substrate. In a preferred embodiment, the contaminated substrate includes a PFAS storage unit, a PFAS contaminated water tank, a PFAS contaminated soil cover, a substrate exposed to firefighting foam.

In an embodiment, the substrate is contaminated with PFAS.

In another embodiment, the substrate is a concrete.

In another embodiment, the system is a reinforced fabric such that the substrate is a fabric and the surface of the fabric is coated with the barrier having polyurea polymer.

### Barrier Material

The barrier encloses the at least one surface of the substrate.

The barrier includes a polyurea polymer formed as a reaction product of an at least one isocyanate, at least one polyol, at least one amine, at least one chain extender and at least one additive.

The barrier having the polyurea polymer encloses the at least one surface of the substrate. The barrier contains the movement of the PFAS from the surface.

In an embodiment, the barrier includes the polyurea polymer enclosed completely or partially across the at least one surface of the substrate.

In a preferred embodiment, the system for containment of PFAS has the barrier having polyurea polymer formed as the reaction product of a mixture comprising:
a. Part A, wherein the part A includes:
   i. at least one first amine;
   ii. optionally, at least one first chain extender;
   iii. optionally, a polyol composition comprising at least one first polyol; and
   iv. optionally, at least one first additive selected from a triol, a curing agent, a slow gelling agent, a catalyst, a molecular sieve, a colorant/a pigment, an antifoaming agent, a stabilizer, a coupling agent, an antioxidant, a mold release agent, a liquid rheology additive, and a thickening agent;
and
b. Part B, wherein the part B includes:
   i. an isocyanate mixture including at least one isocyanate;
   ii. optionally, at least one second polyol;
   iii. optionally, at least one second amine;
   iv. optionally, at least one second additive selected from a propylene carbonate, a benzoyl chloride, a methyldiphenylphosphine oxide, a diisodecyladipate, a trifluromethane sulfonic acid; a diol/a triol.

### Polyurea Polymer

The polyurea polymer is formed as a reaction product of a mixture comprising:
a. Part A; and
b. Part B including an isocyanate composition.

### Part A

The part A includes:
a. at least one first amine;
b. optionally, at least one first chain extender;
c. optionally, a polyol composition comprising at least one first polyol;
d. optionally, at least one additive selected from a triol, a curing agent, a slow gelling agent, a catalyst, a molecular sieve, a colorant/a pigment, an antifoaming agent, a stabilizer, a coupling agent, an antioxidant, a mold release agent, a liquid rheology additive, and a thickening agent.

### Amine:

The at least first amine includes a primary amine and a secondary amine.

In an embodiment, the at least first amine is a primary amine.

In an embodiment the at least first amine is a secondary amine selected from the group consisting of N1,N3-diisopropyl-4-methyl-cyclohexane-1,3-diamine, 4-methyl-N1,N3-disec-butyl-cyclohexane-1,3-diamine, 2-methyl-N1,N3-disec-butyl-cyclohexane-1,3-diamine, N1,N3-dibenzyl-2-methyl-cyclohexane-1,3-diamine, N1,N3-dibenzyl-4-methyl-cyclohexane-1,3-diamine, N1,N3-bis(2-ethylhexyl)-4-methyl-cyclohexane-1,3-diamine, N-isopropyl-3-[(isopropylamino)methyl]-3,5,5-trimethyl-cyclohexanamine, N-sec-butyl-4-[[4-(sec-butylamino)phenyl]methyl]aniline, N,N′-bis(2,2,6,6-tetramethyl-4-piperidyl)hexane-1,6-diamine, N,N′-diethyl-2-butene-1,4-diamine, N,N′-diisopropyl-1,3-propanediamine, N,N′-diisopropylethylenediamine, N,N′-dimethyl-1,3-propanediamine, 1,4,8,11-tetraazacyclotetradecane-5,7-dione, 1,4-diazacycloheptane, 1,2-dimethylethylenediamine, 1,2-diisopropylethylenediamine, N-(pyrrolidin-2-ylmethyl)cyclohexanamine, N-(pyrrolidin-2-ylmethyl)cycloheptanamine and 2-methyl-N-(pyrrolidin-2-ylmethyl)propan-2-amine.

In an embodiment, the at least first amine includes a polyetheramine, a bifunctional primary amine, Poly(propylene glycol) bis(2-aminopropyl ether), and an amine-terminated polyoxypropylene diol.

In an embodiment, the mixture includes the at least first amine in a range of 5.0 wt. % to 60 wt. %. In a more preferred embodiment, the mixture includes the at least first amine in range of 5.0 wt. % to 50 wt. %.

In an embodiment, the at least first amine is selected from polyetheramines, amine catalyst, amine chain extenders. The amine catalyst is different from the catalyst described herein. The amine chain extender is different from the chain extender described herein.

In an embodiment, the at least first amine in the polyurea polymer includes an amine chain extender. The amine chain extender includes Cycloaliphatic secondary amine curing agent with low reactivity, and isophorone diamine.

### Chain Extender:

The at least first chain extender is different from the amine chain extender and the polyol described herein.

In an embodiment, the suitable at least first chain extenders and/or cross linkers are present in in Part A of the reaction mixture of the polyurea polymer. The addition of bifunctional at least first chain extenders, trifunctional and higher-functional cross linkers or, if appropriate, mixtures thereof might be added.

In an embodiment, the at least first chain extender has a molecular weight of less than 499 g/mol. In the context of the present invention, the at least first chain extender is understood to mean a compound having at least two functional groups reactive toward isocyanates, for example hydroxyl groups, amino groups or thiol groups, and a molecular weight of less than 499 g/mol. At the same time, in the context of the present invention, the polyol composition is also free of compounds of this kind.

In another embodiment, the at least first chain extenders and/or cross linkers used are preferably diols and/or triols having molecular weights preferably in between 60 g/mol to 300 g/mol. Suitable amounts of the at least first chain extenders and/or cross linkers can be added and are known to the person skilled in the art.

In a preferred embodiment, the at least first chain extender is in range of 0.0 to 20.0 wt. % of the Part A. In a more preferred embodiment, the at least first chain extender is in range of 0.1 to 20.0 wt. % or in range of 0.2 to 20.0 wt. %, or in range of 0.3 to 20.0 wt. %, or in range of 0.4 to 20.0 wt. %, or in range of 0.5 to 20.0 wt. % of the Part A. In a more preferred embodiment, the at least first chain extender is in range of 0.5 to 18.0 wt. % or in range of 0.5 to 15.0 wt. % of the Part A.

Preferably, the at least first chain extenders have a molecular weight less than 300 g/mol, or from 10 g/mol to 210 g/mol. Another preferred at least first chain extender has a molecular weight from 50 g/mol to 150 g/mol, or from 50 g/mol to 120 g/mol, or from 60 g/mol to 120 g/mol.

Suitable at least first chain extenders can be selected from mono-ethylene glycol, ethylene glycol, 1,2-propanediol, 1,3-propanediol, 1-5 pentanediol, 1,6-hexanediol, 1,10-decanediol, 1,2-dihydroxycyclohexane, 1,3-dihydroxycyclohexane, 1,4-dihydroxycyclohexane, diethylene glycol, 1,4-butanediol, bis(2-hydroxy-ethyl)hydroquinone, dipropylene glycol, glycerol, diethanolamine, and triethanolamine. Preferably, the chain extender can be selected from 1,2-ethylene glycol, 1,3-propylene glycol, 1,4 butane diol, 1,5-pentane diol, 1,6-hexane diol, Hydroquinone Bis (2-hydroxyethyl) Ether (HQEE), or/and hydroxyethylether of resorcinol or 1,3-Bis (2-hydroxyethyl) resorcinol (HER).

In one embodiment, suitable at least first chain extenders and/or cross linkers present in the polyurea polymer composition is further described. The addition of bifunctional chain extenders, trifunctional and higher-functional cross linkers or, if appropriate, mixtures thereof might be added. The at least first chain extenders and/or cross linkers used are preferably diols and/or triols having molecular weights preferably in between 60 g/mol to 300 g/mol. Suitable amounts of the at least first chain extenders and/or cross linkers can be added and are known to the person skilled in the art.

In the context of the present invention, the amount of the at least first chain extender and the polyol composition may vary within wide ranges. Preferably, the weight ratio between the at least first chain extender and the polyol composition is from 0.1:1.0 to 1.0:1.0. In another embodiment, the weight ratio between the at least first chain extender and the polyol composition is from 0.2:1.0 to 0.9:1.0, or from 0.21:1.0 to 0.9:1.0, or from 0.22:1.0 to 0.9:1.0.

For the preparation of the polyurea polymer, a suitable isocyanate index is required to be maintained. The index is defined here as the ratio of the total number of isocyanate groups of the isocyanate composition used in the reaction to the isocyanate-reactive groups, i.e., the groups of polyol composition and the chain extender. At an index of 100, there is one active hydrogen atom per isocyanate group of the isocyanate composition. At indices exceeding 100, there are more isocyanate groups than isocyanate-reactive groups. In an embodiment, the index for preparing the polyurea polymer is from 90 to 110. In a preferred embodiment, the isocyanate index value is 100.

Suitable at least first chain extenders and/or cross linkers can also be present in the reaction mixture, as described hereinabove. The addition of bifunctional chain extenders, trifunctional and higher-functional cross linkers or, if appropriate, mixtures thereof might be added. The at least first chain extenders and/or cross linkers used are preferably diols and/or triols having molecular weights preferably in between 60 g/mol to 300 g/mol. Suitable amounts of these chain extenders and/or cross linkers can be added and are known to the person skilled in the art. For instance, the at least first chain extenders and/or cross linkers can be present in an amount up to 60 wt.-%, or up to 20 wt.-%, based on the total weight of the polyurethane resin composition.

In an embodiment, the at least first chain extenders include monoethylene glycol, Diethylene glycol MFG, 1,4 butanediol (BDO), and diethyltoluenediamine.

In an embodiment, the mixture includes the at least one first chain extender in a range of 0.5 wt. % to 20.0 wt. %. In a preferred embodiment, the mixture includes the at least one first chain extender in a range of 0.5 wt. % to 18 wt. % or in a range of 0.5 wt. % to 15 wt. %, or in a range of 0.5 wt. % to 14.0 wt. %.

In another preferred embodiment, the reaction mixture comprises the at least first chain extender and/or cross linker having a molecular weight in the range of 49 g/mol to 399 g/mol.

### Polyol Composition:

The polyol composition comprises at least one first polyol. In an embodiment, the at least first polyol is selected from polyether polyols, polyester polyols, polyetherester polyols, polytetrahydrofuran, polyester diol, or a combination thereof.

In an embodiment, the at least first polyol composition comprises at least one first polyol having an OH value ranging from 20 mg KOH/g to 1000 mg KOH/g.

Preferably, the at least first polyol has OH value ranging from 20 mg KOH/g to 1000 mg KOH/g, or from 20 mg KOH/g to 950 mg KOH/g, or from 20 mg KOH/g to 900 mg KOH/g.

Preferred at least first polyols used are within the molecular weight distribution from 500 g/mol to 5000 g/mol, or from 550 g/mol to 5000 g/mol, or from 600 g/mol to 5000 g/mol, or from 700 g/mol to 5000 g/mol. In yet another embodiment, the at least first polyols used are with the molecular weight distribution from 800 g/mol to 5000 g/mol, or from 900 g/mol to 5000 g/mol, or from 1000 g/mol to 5000 g/mol, or from 1100 g/mol to 5000 g/mol, or from 1200 g/mol to 5000 g/mol, or from 1300 g/mol to 5000 g/mol, or from 1400 g/mol to 1500 g/mol, or from 1600 g/mol to 5000 g/mol, or from 1700 g/mol to 5000 g/mol. A more preferred at least first polyols is with molecular weight from 1800 g/mol to 4900 g/mol. An even more preferred at least first polyol is with molecular weight in range of 1900 g/mol to 4900 g/mol. An even more preferred at least first polyol is with molecular weight in range of 2000 g/mol to 4800 g/mol.

Preferred polyol composition includes two different first polyols with the molecular weight ratio in range of 1:10 to 10:1, or in range of 1:9 to 9:1 or in the range of 1:8 to 8:1 or in range of 1:7 to 7:1 or in the range of 1:6 to 6:1, or in the range 1:5 to 5:1 or in the range 1:4 to 4:1 or in the range of 1:3 to 3:1 or in the range of 1:2 to 2:1. A more preferred the polyol composition includes two first polyols with molecular weight ratio of 1:1.

Another preferred polyol composition is a polyol mixture (i) based on the mixture of at least two, different polyols that are prepared separately. By the expression “at least two polyol” it is meant that two different polyols are used, which have different mean molecular weight ranges. Preferably, the polyol composition includes a polyol one of molecular weight range of 500 g/mol to 2450 g/mol and a polyol two of molecular weight range of 2500 g/mol to 5000 g/mol in weight ratio of 1:1.

In another embodiment, the polyether polyols are obtainable by known methods, for example by anionic polymerization with alkali metal hydroxides, e.g., sodium hydroxide or potassium hydroxide, or alkali metal alkoxides, e.g., sodium methoxide, sodium ethoxide, potassium ethoxide or potassium isopropoxide, as catalysts and by adding at least one amine-containing starter molecule, or by cationic polymerization with Lewis acids, such as antimony pentachloride, boron fluoride etherate and so on, or fuller's earth, as catalysts from one or more alkylene oxides having 2 to 4 carbon atoms in the alkylene moiety.

Polyether polyols are usually the product of the polymerization of epoxides, such as ethylene oxide (EO), propylene oxide (PO), butylene oxide, styrene oxide or epichlorohydrin, with themselves or by addition of such epoxides, optionally in admixture or sequentially, to starting components with reactive hydrogen atoms, such as water, alcohols, ammonia or amines. Such ‘starter molecules’ usually have a functionality of from 1 to 6. Depending on the process control. Such polyether polyols may be homopolymers, block copolymers, random copolymers, capped polymers or polymers tipped with a mixture of different epoxides.

Starter molecules are generally selected such that their average functionality is preferably in the range of 2.0 to 8.0, and more preferably in the range of 3.0 to 8.0. Optionally, a mixture of suitable starter molecules is used.

Starter molecules for polyether polyols include amine containing and hydroxyl-containing starter molecules. Suitable amine containing starter molecules include, for example, aliphatic and aromatic diamines such as ethylenediamine, propylenediamine, butylenediamine, hexamethylenediamine, phenylenediamines, toluenediamine, diaminodiphenylmethane and isomers thereof.

Other suitable starter molecules further include alkanolamines, e.g. ethanolamine, N-methylethanolamine and N-ethylethanolamine, dialkanolamines, e.g., diethanolamine, N-methyldiethanolamine and N-ethyldiethanolamine, and trialkanolamines, e.g., triethanolamine, and ammonia.

Suitable amine containing starter molecules are selected from ethylenediamine, phenylenediamines, toluenediamine or isomers thereof. In one embodiment, it is ethylenediamine.

Hydroxyl-containing starter molecules are selected from sugars, sugar alcohols, for e.g. glucose, mannitol, sucrose, pentaerythritol, sorbitol; polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

Suitable hydroxyl containing starter molecules are selected from sugar and sugar alcohols such as sucrose, sorbitol, glycerol, pentaerythritol, trimethylolpropane or mixtures thereof. In some embodiments the hydroxyl containing starter molecules are selected from sucrose, glycerol, pentaerythritol or trimethylolpropane.

Suitable alkylene oxides having 2 to 4 carbon atoms are, for example, ethylene oxide, propylene oxide, tetrahydrofuran, 1,2-butylene oxide, 2,3-butylene oxide, and styrene oxide. Alkylene oxides can be used singly, alternatingly in succession or as mixtures. In one embodiment, the alkylene oxides are propylene oxide and/or ethylene oxide. In some embodiments, the alkylene oxides are mixtures of ethylene oxide and propylene oxide that comprise more than 50 wt.-% of propylene oxide.

In another preferred embodiment, the amount of the polyether polyols is in the range of 1 wt.-% to 99 wt.-%, based on the total weight of the reaction mixture.

In another preferred embodiment, the suitable polyester polyols have an average functionality in the range of 2.0 to 6.0, more preferably in the range of 2.0 to 5.0, and most preferably in the range of 2.0 to 4.0 and a hydroxyl number in the range of 30 mg KOH/g to 250 mg KOH/g, and most preferably in the range of 100 mg KOH/g to 200 mg KOH/g.

In another preferred embodiment, the polyester polyols are based on the reaction product of carboxylic acids or anhydrides with hydroxy group containing compounds. Suitable carboxylic acids or anhydrides have preferably from 2 to 20 carbon atoms, or from 4 to 18 carbon atoms, for example succinic acid, glutaric acid, adipic acid, suberic acid, azelaic acid, sebacic acid, decanedicarboxylic acid, maleic acid, fumaric acid, phthalic acid, isophthalic acid, terephthalic acid, oleic acid, phthalic anhydride. Particularly comprising of phthalic acid, isophthalic acid, terephthalic acid, oleic acid and phthalic anhydride or a combination thereof.

Suitable hydroxyl containing compounds are selected from ethanol, ethylene glycol, propylene-1,2-glycol, propylene-1,3-glycol, butyl-ene-1,4-glycol, bu-tylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside, diethylene glycol, triethylene glycol, tetraethylene glycol, polyethylene glycol, dipropylene glycol, polypropylene glycol, polyethylenepropylene glycol, dibutylene glycol or polybutylene glycol. In one embodiment, the hydroxyl containing compound is selected from ethylene glycol, propylene-1,2-glycol, propylene-1,3-glycol, butylene-1,4-glycol, butylene-2,3-glycol, hexane-1,6-diol, octane-1,8-diol, neopentyl glycol, cyclohexane dimethanol (1,4-bis-hydroxy-methylcyclohexane), 2-methyl-propane-1,3-diol, glycerol, trimethylolpropane, hexane-1,2,6-triol, butane-1,2,4-triol, trimethylolethane, pentaerythritol, quinitol, mannitol, sorbitol, methyl glycoside or diethylene glycol. In another embodiment, the hydroxyl containing compound is selected from ethylene glycol, propylene-1,2-glycol, pro-pylene-1,3-glycol, butyl-ene-1,4-glycol, butylene-2,3-glycol, hexane-1,6-diol, octane-1,8-diol, neopentyl glycol or diethylene glycol. In still another embodiment, the hydroxyl containing compound is selected from hexane-1,6-diol, neopentyl glycol and diethylene glycol.

Suitable polyetherester polyols have a hydroxyl number in the range of 100 mg KOH/g to 460 mg KOH/g, more preferably in the range of 150 mg KOH/g to 450 mg KOH/g, most preferably in the range of 250 mg KOH/g to 430 mg KOH/g and in any of these embodiments may have an average functionality in the range of 2.3 to 5.0, and most preferably in the range of 3.5 to 4.7.

Such polyetherester polyols are obtainable as a reaction product of i) at least one hydroxyl-containing starter molecule; ii) of one or more fatty acids, fatty acid monoesters or mixtures thereof; iii) of one or more alkylene oxides having 2 to 4 carbon atoms.

The starter molecules of component i) are generally selected such that the average functionality of component i) is preferably 3.8 to 4.8, or from 4.0 to 4.7, or even from 4.2 to 4.6. Optionally, a mixture of suitable starter molecules is used.

Suitable hydroxyl containing starter molecules of component i) are selected from sugars, sugar alcohols (glucose, mannitol, sucrose, pentaerythritol, sorbitol), polyhydric phenols, resols, e.g., oligomeric condensation products formed from phenol and formaldehyde, trimethylolpropane, glycerol, glycols such as ethylene glycol, propylene glycol and their condensation products such as polyethylene glycols and polypropylene glycols, e.g., diethylene glycol, triethylene glycol, dipropylene glycol, and water or a combination thereof.

In another preferred embodiment, the hydroxyl containing starter molecules of component i) are selected from sugars and sugar alcohols such as sucrose and sorbitol, glycerol, and mixtures of said sugars and/or sugar alcohols with glycerol, water and/or glycols such as, for example, diethylene glycol, dipropylene glycol or combination thereof.

Said fatty acid or fatty acid monoester ii) is selected from polyhydroxy fatty acids, ricinoleic acid, hydroxyl-modified oils, hydroxyl-modified fatty acids and fatty acid esters based in myristoleic acid, palmitoleic acid, oleic acid, stearic acid, palmitic acid, vaccenic acid, petroselic acid, gadoleic acid, erucic acid, nervonic acid, linoleic acid, a- and g-linolenic acid, stearidonic acid, arachidonic acid, timnodonic acid, clupanodonic acid and cervonic acid or a combination thereof. Fatty acids can be used as purely fatty acids. In this regard, preference is given to using fatty acid methyl esters such as, for example, biodiesel or methyl oleate.

Biodiesel is to be understood as meaning fatty acid methyl esters within the meaning of the EN 14214 standard from 2010. Principal constituents of biodiesel, which is generally produced from rapeseed oil, soybean oil or palm oil, are methyl esters of saturated C16 to C18 fatty acids and methyl esters of mono- or pol-yunsaturated C18 fatty acids such as oleic acid, linoleic acid and linolenic acid.

Suitable alkylene oxides iii) having 2 to 4 carbon atoms are, for example, ethylene oxide, propylene oxide, tetrahydrofuran, 1,2-butylene oxide, 2,3-butylene oxide and/or styrene oxide. Alkylene oxides can be used singly, alternatingly in succession or as mixtures.

In another preferred embodiment, the alkylene oxides comprise propylene oxide and ethylene oxide. In another preferred embodiment, the alkylene oxide is a mixture of ethylene oxide and propylene oxide comprising more than 50 wt.-% of propylene oxide. In another embodiment, the alkylene oxide comprises purely propylene oxide.

### Additive:

The part A includes optionally, at least one first additive. The first additives can be selected from catalyst, triol, curing agent, slow gelling agent, molecular sieve, colorant/pigments, antifoam, stabilizer (Light/UV), coupling agent, antioxidant, mold release agent, liquid rheology additive, triols/sieve blend, thickening agent, dyes, surfactants, flame retardants, hindered amine light stabilizers, ultraviolet light absorbers, defoamers, internal release agents, desiccants, blowing agents, and antistatic agents or a combination thereof. Further details regarding additives can be found, for example, in the Kunststoffhandbuch, Volume 7, “Polyurethane” Carl-Hanser-Verlag Munich, 1st edition, 1966 2nd edition, 1983 and 3rd edition, 1993. Suitable amounts of these additives are well known to the person skilled in the art. However, for instance, the additives can be present in amounts from 0.0 to 20.0 wt. % based on the total weight of the reaction mixture.

In an embodiment, the at least one first additive include a triol, a curing agent, a slow gelling agent, a catalyst, a molecular sieve, a colorant/a pigment, an antifoaming agent, a stabilizer, a coupling agent, an antioxidant, a mold release agent, a liquid rheology additive, and a thickening agent.

### Antifoam

In an embodiment, the polyurea polymer includes an antifoam. The antifoam includes compounded silicone.

### Antioxidant

If the Polyurea polymer has exposure to thermoxidative degradation during its use, antioxidants can be added. It is preferable to use phenolic antioxidants. Examples of phenolic antioxidants are given in Plastics Additive Handbook, 5th edition, H. Zweifel, ed, Hanser Publishers, Munich, 2001, pp. 98-107 and pp. 116-121. Preference is given to those phenolic antioxidants whose molar mass is greater than 700 g/mol. An example of a phenolic antioxidant whose use is preferred is pentaerythrityl tetrakis(3-(3,5-bis(1,1-dimethylethyl)-4-hydroxyphenyl)propionate) (Irganox® 1010), N,N′-(hexane-1,6-diyl)bis[3-(3,5-di-tert-butyl-4-hydroxyphenyl) propenamide] or blends thereof. The concentrations generally used of the phenolic antioxidants are from 0.1 to 5% by weight, preferably from 0.1 to 2% by weight, in particular from 0.5 to 1.5% by weight, based in each case on the total weight of the PU.

In an embodiment the polyurea polymer includes an antioxidant. The antioxidant includes phenolic primary antioxidant.

### Antistatic Agents:

Antistatic additives and antistatic polymers are known. By way of example, DE 3531660 describes antistatic polyurethane shoe soles. The antistatic effect is achieved via from 0.01 to 0.3% by weight of chemically bonded sulfonate groups. The volume resistivities achieved are <10⁸ Ω/cm. The use of various quaternary ammonium salts for increasing the conductivity of polymers is described in EP 1134268. This involves modifications of commercially available antistatic agents, such as Catafor F® or Catafor PU® from Rhodia. For example, volume resistivities of about 107 Ω/cm are achieved at high concentrations.

Antistatic additives include ethylmethylimidazole ethyl sulfate. Ethylmethylimidazole ethyl sulfate can be used here alone or in a mixture, for example together with other antistatic additives. It is preferable that ethylmethylimidazole ethyl sulfate is used as sole antistatic additive.

In an embodiment, the antistatic agent is selected from Soyabean oil with C10 to C16 Carbon chains, 1-Ethyl-3-methyl imidazolium dicyanamide, alkali metal salts in solvent, phosphoric acid and triethyl ether, metallic salt and polyether.

### Catalyst:

Suitable catalysts are well known to the person skilled in the art. For instance, tertiary amine and phosphine compounds, metal catalysts such as chelates of various metals, acidic metal salts of strong acids; strong bases, alcoholates and phenolates of various metals, salts of organic acids with a variety of metals, organometallic derivatives of tetravalent tin, trivalent and pentavalent As, Sb and Bi and metal carbonyls of iron and cobalt and mixtures thereof can be used as catalysts.

Suitable tertiary amines include, such as triethylamine, tributylamine, N-methylmorpholine, N-ethylmorpholine, N,N,N′,N′-tetramethylethylenediamine, pentamethyl-diethylenetriamine and higher homologues (as described in, for example, DE-A 2,624,527 and 2,624,528), 1,4-diazabicyclo(2.2.2)octane, N-methyl-N′-dimethyl-aminoethylpiperazine, bis-(dimethylaminoalkyl)piperazines, tris(dimethylaminopropyl)hexahydro-1,3,5-triazin, N,N-dimethylbenzylamine, N,N-dimethylcyclohexylamine, N,N-diethyl-benzylamine, bis-(N,N-diethylaminoethyl) adipate, N,N,N′,N′-tetramethyl-1,3-butanediamine, N,N-dimethyl-p-phenylethylamine, 1,2-dimethylimidazole, 2-methylimidazole, monocyclic and bicyclic amines together with bis-(dialkylamino)alkyl such ethers, as 2,2-bis-(dimethylaminoethyl)ether. Triazine compounds, such as, but not limited to, tris(dimethylaminopropyl)hexahydro-1,3,5-triazin can also be used.

Suitable metal catalysts include metal salts and organometallics comprising tin-, titanium-, zirconium-, hafnium, bismuth-, zinc-, aluminium- and iron compounds, such as tin organic compounds, preferably tin alkyls, such as dimethyltin or diethyltin, or tin organic compounds based on aliphatic carboxylic acids, preferably tin diacetate, tin dilaurate, dibutyl tin diacetate, dibutyl tin dilaurate, bismuth compounds, such as bismuth alkyls or related compounds, or iron compounds, preferably iron-(II)-acetylacetonate or metal salts of carboxylic acids, such as tin-II-isooctoate, tin dioctoate, titanium acid esters or bismuth-(III)-neodecanoate or a combination thereof.

In an embodiment, the catalyst includes triethylenediamine, bismuth catalyst, 1-(3-(dimethylamino)propyl)urea.

The catalysts, as described hereinabove, can be present in amounts preferably up to 20 wt.-% based on the total weight of the reaction mixture.

### Colorant/Pigment:

The polyurea polymer may include a colorant/pigment. The pigment/colorant includes black soot, green Repitan, TiO2/rutile titanium dioxide pigment, polyol black colour.

### Coupling Agent

The polyurea polymer may include a coupling agent. The coupling agent includes a silane coupling agent.

### Diol/Triol

The polyurea polymer may include a diol/triol. The diol/triol includes ethylene oxide capped diol, and castor oil, pre-blend of triol.

### Friction Reducers:

The friction reducers include polyethylene and polytetrafluoroethylene (PTFE) powders. Polyethylene include non-crosslinked polyethylene. In an embodiment, the non-cross linked polyethylene includes high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE)

### Fillers:

Suitable fillers include, such as, but not limited to, silicatic minerals, examples being finely ground quartzes, phyllosilicates, such as antigorite, serpentine, hornblendes, amphibols, chrysotile, and talc; metal oxides, such as kaolin, aluminum oxides, aluminium hydroxides, magnesium hydroxides, hydromagnesite, titanium oxides and iron oxides, metal salts such as chalk, heavy spar and inorganic pigments, such as cadmium sulfide, zinc sulfide, and also glass and others. Preference is given to using kaolin (china clay), finely ground quartzes, aluminum silicate, and coprecipitates of barium sulfate and aluminum silicate.

Suitable fillers have an average particle diameter in the range of 0.1 μm to 500 μm, more preferably in the range of 1 μm to 100 μm, and most preferably in the range of 1 μm to 10 μm. Diameter in this context, in the case of non-spherical particles, refers to their extent along the shortest axis in space.

Suitable amounts of the fillers can be present in the polyurethane resin composition which are known to the person skilled in the art. For instance, fillers can be present in an amount up to 50 wt.-%, based on the total weight of the polyurethane resin composition.

### Flame Retardants:

Suitable flame retardants are tetrabromobisphenol A, brominated polystyrene oligomers, brominated butadiene-polystyrene copolymers in accordance with WO 2007/058736, tetrabromobisphenol A diallyl ether, and hexabromocyclododecane (HBCD), in particular the industrial products, where these in essence comprise the α-, β-, and γ-isomer with added synergists, such as dicumyl. Preference is given to brominated aromatics, such as tetrabromobisphenol A, and to brominated styrene oligomers. Examples of suitable halogen-free flame retardants are expandable graphite, red phosphorus, and phosphorus compounds, such as triphenyl phosphate and 9,10-dihydro-9-oxa-10-phosphaphenanthrene 10-oxide.

In a preferred embodiment, the flame retardant is graphite. The graphite includes graphite ore treated with sulfuric acid by intercalation process. The graphite ore has bulk density in range of 0.45 to 0.60 g/cm³.

Preferred phosphorus compounds are tris(2-chloroisopropyl) phosphate, triethyl phosphate, diethyl ethylphosphonate, cresyl diphenyl phosphate, Exolit OP560, diphenyl 6-(diphenoxyphosphoryloxy)hexahydrofuro[3,2-b]furan-3-yl phosphate, 9,10-dihydro-9-oxa-10-phosphaphenanthrene 10-oxide, and 6H-dibenzo[c,e][1,2]oxaphosphorine 6-oxide.

Preference is moreover given to organic peroxides (dicumyl peroxide), sulfur, and disulfides as synergists. The abovementioned flame retardants can either be dissolved in the monomers before the polymerization reaction starts.

In another preferred embodiment, the flame retardant is selected from triaryl phosphate isoproxyliert as well as a halogen free, flame retardant additive, comprising salt of melamine and cyanuric acid.

### Rheology Additive

In an ebmodiment, the rheology additive includes rheology modifying wax emulsion, bentonite, etc.

### Mold Release Agents:

Mold release agents include release agents based on wax or silicon, mold release agents based on salts of aliphatic mono- or polycarboxylic acids having at least 25 carbon atoms, and primary mono-, di-, or polyamines having two or more carbon atoms, or amide or ester group-containing amines, which have at least one primary, secondary or tertiary amino group, release agents based on mixtures of at least two compounds from the group of amine-carboxylic acid-salts, saturated or unsaturated CeOH- and/or OH group-containing esters from mono- and/or poly carboxylic acids, and multivalent alcohols or natural and/or synthetic oils, fats or waxes, mold release agents based on ketimines, aldimines, enamines or cyclic Schiff bases. In an embodiment, the mold release agent used is Ethylene-bis-stearamide. In another embodiment the mold release agent is a silicone surfactant.

### Molecular Sieve

In an embodiment, the polyurea polymer includes a molecular sieve. The molecular sieve includes a 3 angstrom sized sieve, KnNa12-n[(AlO2)12(SiO2)12]·xH2O, 3Angstrom poly paste, and castor-oil plant slurry oil that contains zeolite.

### Slow Gelling Agent

In an embodiment, the polyurea polymer includes a slow gelling agent. The slow gelling agent includes an aromatic diamine.

### Stabilizers

Hydrolysis stabilizers used preferably comprise oligomeric and/or polymeric aliphatic or aromatic carbodiimides.

In order to stabilize the polyurea polymer, with respect to aging, it is preferable that stabilizers are added to the polyurea polymer. For the purposes of the present invention, stabilizers are additives which protect a plastic or a plastics mixture from damaging environmental effects. Examples are primary and secondary antioxidants, hindered amine light stabilizer, UV absorber, hydrolysis stabilizer, quencher, and flame retardant. Examples of commercial stabilizers are given in Plastics Additive Handbook, 5th Edition, H. Zweifel, ed., Hanser Publishers, Munich, 2001 ([1]), pp. 98-136. In an embodiment, the hydrolysis stabilizer includes Benzene, 1,3-bis(1-isocyanato-1-methylethyl)-, homopolymer, polyethylene glycol mono-Me-ether-blocked.

### Thickening Agent

In an embodiment, the polyurea polymer includes a thickening agent. The thickening agent includes fumed silica/pyrogenic silica.

### UV Absorber

If the Polyurea polymer optionally include a UV absorber. UV absorbers are molecules which absorb high-energy UV light and dissipate the energy. Familiar UV absorbers used industrially are, for example, members of the group of cinnamic esters, of diphenylcyanoacrylates, of the formamidines, of the benzylidenemalonates, of the diarylbutadienes, or triazines, or of the benzotriazoles. Examples of commercial UV absorbers are found in Plastics Additive Handbook, 5th edition, H. Zweifel, ed, Hanser Publishers, Munich, 2001, pp. 116-122. In one preferred embodiment, the number-average molar mass of the UV absorbers is greater than 300 g/mol, in particular greater than 390 g/mol. The UV absorbers preferably used should moreover have molar mass no greater than 5000 g/mol, particularly preferably no greater than 2000 g/mol. The benzotriazoles group is particularly suitable as UV absorber. Examples of particularly suitable benzotriazoles are Tinuvin® 213, Tinuvin® 328, Tinuvin® 571, and also Tinuvin® 384, and Eversorb®82. The amounts preferably added of the UV absorbers are from 0.01 to 5% by weight, based on the total weight of antistatic, polyurethane, particularly preferably from 0.1 to 2.0% by weight, in particular from 0.2 to 0.5% by weight, based in each case on the total weight of the antistatic polyurethane.

Particularly suitable UV absorbers are from the group of benzotriazoles. Examples of particularly suitable benzotriazoles are Tinuvin® 213, Tinuvin® 234, Tinuvin® 571 and Tinuvin® 384, Ever-Sorb®82, Tinuvin 312 (i.e. Oxanilide UV absorber, Ethane diamide, N-(2-ethoxyphenyl)-N′-(2-ethylphenyl), and Tinuvin 328 (i.e. CAS No. 25973-55-1, Chemical formula: 2-(2H-benzotriazol-2-yl)-4,6-ditertpentylphenol). The UV absorbers are usually added in amounts of from 0.01 to 5% by weight, based on the total mass of the PU, preferably 0.1-2.0% by weight, in particular 0.2-0.5% by weight.

### HALS (Hindered Amine Light Stabilizer)

A UV stabilization as described above based on an antioxidant and a UV absorber is often still not sufficient to ensure good stability of the film against the damaging influence of UV rays. In this case, a hindered amine light stabilizer (HALS) can be added in addition to the antioxidant and the UV absorber to the film. HALSs are highly efficient UV stabilizers for most polymers.

HALS compounds are generally known and commercially available. Examples of commercially available HALSs may be found in Plastics Additive Handbook, 5th edition, H. Zweifel, Hanser Publishers, Munich, 2001, pp. 123-136.

As hindered amine light stabilizers, preference is given to employing hindered amine light stabilizers in which the number average molecular weight is greater than 500 g/mol. Furthermore, the molecular weight of the preferred HALS compounds should be not greater than 10,000 g/mol, particularly preferably not greater than 5000 g/mol.

Particularly preferred hindered amine light stabilizers are bis(1,2,2,6,6-pentamethylpiperidyl) se-bacate (Tinuvin® 765, Ciba Spezialitatenchemie AG) and the condensation product of 1-hydrox-yethyl-2,2,6,6-tetramethyl-4-hydroxypiperidine and succinic acid (Tinuvin® 622). Particular preference is given to the condensation product of 1-hydroxyethyl-2,2,6,6-tetramethyl-4-hydrox-ypiperidine and succinic acid (Tinuvin® 622) when the titanium content of the product is <150 ppm, preferably <50 ppm, in particular <10 ppm. HALS compounds are preferably used in a concentration of from 0.01 to 5% by weight, particularly preferably from 0.1 to 1% by weight, in particular from 0.15 to 0.3% by weight referring to the total weight of the film.

In a preferred embodiment of the film, hydrolysis inhibitors are comprised in the Polyurea polymer as auxiliaries; preference is given here to oligomeric and/or polymeric aliphatic or aromatic carbodiimides.

Further details regarding the abovementioned auxiliaries and additives may be found in the specialist literature, for example in Plastics Additive Handbook, 5th edition, H. Zweifel, ed., Hanser Publishers, Munich, 2001.

### Part B

The part B includes:
a. an isocyanate mixture including at least one isocyanate;
b. optionally, at least one second polyol;
c. optionally, at least one second amine;
d. optionally, at least one second additive selected from a propylene carbonate, a benzoyl chloride, a methyldiphenylphosphine oxide, a diisodecyladipate, a trifluromethane sulfonic acid; a diol/a triol.

### Isocyanate Mixture:

The isocyanate mixture includes at least one isocyanate. The isocyanate mixture has an average NCO functionality of ≥2.10.

The isocyanates can be selected from aliphatic isocyanates, aromatic isocyanates, and a combination thereof. By the term “aromatic isocyanate”, it is referred to molecules having two or more isocyanate groups attached directly and/or indirectly to the aromatic ring. Further, it is to be understood that the isocyanate includes both monomeric and polymeric forms of the aliphatic and aromatic isocyanate. By the term “polymeric”, it is referred to the polymeric grade of the aliphatic and/or aromatic isocyanate comprising, independently of each other, different oligomers, and homologues.

In another embodiment, the isocyanate comprises an aromatic isocyanate selected from toluene diisocyanate; polymeric toluene diisocyanate, methylene diphenyl diisocyanate; polymeric methylene diphenyl diisocyanate; m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate; 1-methyl-3,5-diethylphenylene-2,4-diisocyanate; 1,3,5-triethylphenylene-2,4-diisocyanate; 1,3,5-triisoproply-phenylene-2,4-diisocyanate; 3,3′-diethyl-bisphenyl-4,4′-diisocyanate; 3,5,3′,5′-tetraethyl-diphenylmethane-4,4′-diisocyanate; 3,5,3′,5′-tetraisopropyldiphenylmethane-4,4′-diisocyanate; 1-ethyl-4-ethoxy-phenyl-2,5-diisocyanate; 1,3,5-triethyl benzene-2,4,6-triisocyanate; 1-ethyl-3,5-diisopropyl benzene-2,4,6-triisocyanate, tolidine diisocyanate, 1,3,5-triisopropyl benzene-2,4,6-triisocyanate and mixtures thereof. In other embodiment, the aromatic isocyanate is selected from toluene diisocyanate; polymeric toluene diisocyanate, methylene diphenyl diisocyanate; polymeric methylene diphenyl diisocyanate, m-phenylene diisocyanate; 1,5-naphthalene diisocyanate; 4-chloro-1; 3-phenylene diisocyanate; 2,4,6-toluylene triisocyanate, 1,3-diisopropylphenylene-2,4-diisocyanate and 1-methyl-3,5-diethylphenylene-2,4-diisocyanate. In other embodiments, the aromatic isocyanate is selected from toluene diisocyanate; polymeric toluene diisocyanate, methylene diphenyl diisocyanate; polymeric methylene diphenyl diisocyanate, m-phenylene diisocyanate and 1,5-naphthalene diisocyanate or a combination thereof. In still other embodiment, the aromatic isocyanate is selected from toluene diisocyanate; polymeric toluene diisocyanate, methylene diphenyl diisocyanate and polymeric methylene diphenyl diisocyanate or mixture thereof.

In another preferred embodiment, the aromatic isocyanate selected from methylene diphenyl diisocyanate, polymeric methylene diphenyl diisocyanate or combination thereof.

In another preferred embodiment, the methylene diphenyl diisocyanate is available in three different isomeric forms, namely 2,2′-methylene diphenyl diisocyanate (2,2′-MDI), 2,4′-methylene diphenyl diisocyanate (2,4′-MDI) and 4,4′-methylene diphenyl diisocyanate (4,4′-MDI). Methylene diphenyl diisocyanate can be classified into monomeric methylene diphenyl diisocyanate and polymeric methylene di-phenyl diisocyanate referred to as technical methylene diphenyl diisocyanate. Polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of higher than 2. The isomeric ratio as well as the amount of oligomeric species can vary in wide ranges in these products. For instance, polymeric methylene diphenyl diisocyanate may typically contain 30 wt.-% to 80 wt.-% of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene di-phenyl diisocyanate.

In another preferred embodiment, the isocyanate comprises a polymeric methylene diphenyl diisocyanate. Commercially available isocyanates available under the tradename, such as, but not limited to, Lupranat® from BASF can also be used for the purpose of the present invention.

In another preferred embodiment, the aliphatic isocyanate is selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, ethyl ester l-lysine triisocyanate, 1,6,11-triisocyanatoundecane, (2,4,6-trioxotriazine-1,3,5(2 h,4 h,6h)-triyl)tris(hexamethylene) isocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, triphe-nylmethane-4,4′,4″-triisocyanate, toluene-2,4,6-triyl triisocyanate, tris(isocyanatohexyl)biuret, trimethyl-cyclohexyl] triisocyanate, 2,4,4′-triisocyanato-dicyclohexylmethane, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocy ano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl amine,3,3-diisocyanato adamantane, 3,3-diisocyano biadamantane, 3,3-diiso-cyanatoethyl-1′-biadamantane, 1,2-bis(3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclo-hexane, 1,2-diisocyanato octadecane, 2,5-diisocyanato-1,3,4-oxadiazole, OCN(CH2)3O(CH2)2O(CH2)3NCO and OCN(CH2)3N(CH3)(CH2)3NCO or polymeric forms of diisocyanates; more preferably the aliphatic isocyanate selected from isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate1,5-pentamethylene diisocyanate, 1,6,11-triisocyanatoundecane, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane or polymeric forms of diisocyanates; and most preferably the aliphatic isocyanate selected from isophorone diisocyanate, hexamethylene-1,6-diisocyanate, 2-methylpentamethylene-1,5-diisocyanate, 1,5-pentamethylene diisocyanate, 1 octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane and polymeric forms of diisocyanates or mixtures thereof.

In another preferred embodiment, the at least one isocyanate which has an NCO functionality of ≥2.0 is selected from the group consisting of triphenylmethane-4,4′,4″-triisocyanate, toluene-2,4,6-triyl triisocyanate, ethyl ester l-lysine triisocyanate, 1,6,11-triisocyanatoundecane, 2,2-bis[[4-(isocyanatomethyl)phenyl]methyl]butyl n-[[4-(isocyanatomethyl)phenyl]methyl]carbamate, (2,4,6-trioxotriazine-1,3,5(2 h,4 h,6h)-triyl)tris(hexamethylene) isocyanate, 1,3,5-triisocyanatobenzene, tris(isocyanatohexyl)biuret, 3,3′,3″-[(1 h,3 h,5h)-2,4,6-trioxo-1,3,5-triazine-1,3,5-triyltris(methylene)]tris[3,5,5-trimethylcyclohexyl] triisocyanate, 1,3,5-triazine-2,4,6-triisocyanate, 2,4,4′-triisocyanato-dicyclohexylmethane, triisocyanate triphenylthiophosphate, 2,4,4′-diphenylether triisocyanate and polymeric forms of triisocyanates.

By the term “polymeric”, it is referred to the polymeric grade of the aliphatic polyisocyanate and/or aromatic polyisocyanate comprising, independently of each other, different oligomers and homologues.

In another preferred embodiment, the polymeric form of the diisocyanate is polymeric methylene diphenyl diisocyanate.

In another preferred embodiment, the polymeric forms of diisocyanates and triisocyanates comprise polymeric methylene diphenyl diisocyanate and toluene diisocyanate.

In another preferred embodiment, the polymeric methylene diphenyl diisocyanate includes oligomeric species and methylene diphenyl diisocyanate isomers. Thus, polymeric methylene diphenyl diisocyanate may contain a single methylene diphenyl diisocyanate isomer or isomer mixtures of two or three methylene diphenyl diisocyanate isomers, the balance being oligomeric species. Polymeric methylene diphenyl diisocyanate tends to have isocyanate functionalities of ≥2.10, preferably ≥3.0. The isomeric ratio as well as the amount of oligomeric species can vary in wide ranges in these products. For instance, polymeric methylene diphenyl diisocyanate may typically contain about 30 to 80 wt. % of methylene diphenyl diisocyanate isomers, the balance being said oligomeric species. The methylene diphenyl diisocyanate isomers are often a mixture of 4,4′-methylene diphenyl diisocyanate, 2,4′-methylene diphenyl diisocyanate and very low levels of 2,2′-methylene diphenyl diisocyanate.

In another preferred embodiment, wherein the isocyanate mixture comprises at least one isocyanate which has an NCO functionality of 2.0.

In another preferred embodiment, the at least one isocyanate which has an NCO functionality of equal to or greater than 2.0, is selected from the group consisting of isophorone diisocyanate, propylene-1,2-diisocyanate, propylene-1,3-diisocyanate, butylene-1,2-diisocyanate, butylene-1,3-diisocyanate, hexamethylene-1,6-diisocyanate, 2-methylpentamethylene-1,5-diisocyanate, 2-ethylbutylene-1,4-diisocyanate, 1,5-pentamethylene diisocyanate, methyl-2,6-diisocyanate caproate, octamethlyene-1,8-diisocyanate, 2,4,4-trimethylhexamethylene-1,6-diisocyanate, nonamethylene diisocyanate, 2,2,4-trimethylhexamethylene-1,6-diisocyanate, decamethylene-1,10-diisocyanate, 2,11-diisocyanato-dodecane, meta-phenylene diisocyanate, para-phenylene diisocyanate, toluene-2,4-diisocyanate, toluene-2,6-diisocyanate, xylene-2,4-diisocyanate, xylene-2,6-diisocyanate, methylpropylbenzene diisocyanate, methylethylbenzene diisocyanate, 2,2′-biphenylene diisocyanate, 3,3′-biphenylene diisocyanate, 4,4′-biphenylene diisocyanate, 3,3′-dimethyl-4,4′-biphenylene diisocyanate, methylene-bis(4-phenyl isocyanate), ethylene-bis(4-phenyl isocyanate), isopropylidene-bis(4-phenyl isocyanate), butylene-bis(4-phenylisocyanate), 2,2′-oxydiphenyl diisocyanate, 3,3′-oxydiphenyl diisocyanate, 4,4′-oxydiphenyl diisocyanate, 2,2′-ketodiphenyl diisocyanate, 3,3′-ketodiphenyl diisocyanate, 4,4′-ketodiphenyl diisocyanate, 2,2′-mercaptodiphenyl diisocyanate, 3,3′-mercaptodiphenyl diisocyanate, 4,4′-thiodiphenyl diisocyanate, 2,2′-diphenylsulfone diisocyanate, 3,3′-diphenylsulfone diisocyanate, 4,4′-diphenylsulfone diisocyanate, 2,2,-methylene-bis(cyclohexyl isocyanate), 3,3′-methylene-bis(cyclohexyl isocyanate), 4,4′-methylene-bis(cyclohexyl isocyanate), 4,4′-ethylene-bis(cyclohexyl isocyanate), 4,4′-propylene-bis-(cyclohexyl isocyanate), bis(paraisocyano-cyclohexyl)sulfide, bis(para-isocyanato-cyclohexyl)sulfone, bis(para-isocyano-cyclohexyl)ether, bis(para-isocyanato-cyclohexyl)diethyl silane, bis(para-isocyanato-cyclohexyl)diphenyl silane, bis(para-isocyanato-cyclohexyl)ethyl phosphine oxide, bis(para-isocyanato-cyclohexyl)phenyl phosphine oxide, bis(para-isocyanato-cyclohexyl)N-phenyl amine, bis(para-isocyanato-cyclohexyl)N-methyl 3,3′-dimethyl-4,4′-diisocyano biphenyl, 3,3′-dimethoxy-biphenylene diisocyanate, 2,4-bis(b-isocyanato-t-butyl) toluene, bis(para-b-isocyanato-t-butyl-phenyl)ether, para-bis(2-methyl-4-isocyanatophenyl)benzene, 3,3-diisocyanato adamantane, 3,3-diisocyano biadamantane, 3,3-diiso-cyanatoethyl-1′-biadamantane, 1,2-bis(3-isocyanato-propoxy)ethane, 2,2-dimethyl propylene diisocyanate, 3-methoxy hexamethylene-1,6-diisocyanate, 2,5-dimethyl heptamethylene diisocyanate, 5-methyl nonamethylene-1,9-diisocyanate, 1,4-diisocyanato cyclohexane, 1,2-diisocyanato octadecane, 2,5-diisocyanato-1,3,4-oxadiazole, OCN(CH2)3O(CH2)2O(CH2)3NCO and OCN(CH2)3N(CH3)(CH2)3NCO.

In another preferred embodiment, the polymeric forms of diisocyanates comprise polymeric methylene diphenyl diisocyanate and toluene diisocyanate.

In another preferred embodiment, the at least one isocyanate is present in the form of a dimer, a trimer or an oligomer containing a urethane group, an isocyanurate group, a biuret group, an uretdione group, an allophanate group and/or an iminooxadiazinedione group.

In another preferred embodiment, the part B includes an isocyanate selected from 2,4-MDI, 4,4′-MDI (methylene diphenyl diisocyanate), a 50/50 blend of 2,4-MDI and 4,4-MDI, a carbodiimide modified isocyanate, carbodiimide modified diphenylmethane-4,4-diisocyanate (MDI), and ISOPHORONE Diisocyanate IPDI/aliphatic diisocyanate.

Polyurea polymer has a weight average molecular weight in the range of 500 g/mol to 10,000 g/mol, determined according to the DIN 55672 or in case of high molecular weights where the polymeric material is not soluble in standard organic solvents anymore the molecular weight is determined according to the MALDI-TOF Mass Spectrometry

### Polyol

In an embodiment, the part B of the mixture optionally includes at least one second polyol.

The at least one second polyol is similar to the at least one first polyol as defined herein above. However the at least one first polyol and the at least one second polyol are two polyols independent of each other.

In a preferred embodiment, the at least one second polyol includes a high molecular weight triol, and propylene oxide to a propylene glycol nucleus.

In an embodiment, the part B of the mixture includes at least one second polyol in range of 0 wt. % to 70 wt. %. In a preferred embodiment, the at least one second polyol is present in range of 20 wt. % to 65 wt. %.

### Amine

In an embodiment, the part B of the mixture optionally includes at least one second amine.

The at least second amine is similar to the at least one first amine as defined herein above. However the at least one first amine and the at least one second amine are two amines independent of each other.

In a preferred embodiment, the at least one second amine includes a Poly(propylene glycol) bis(2-aminopropyl ether).

In an embodiment, the part B of the mixture includes at least one second amine in range of 0 wt. % to 50 wt. %.

### Second Chain Extender

In an embodiment, the part B of the mixture optionally includes second chain extender.

The least one second chain extender is similar to the at least one first chain extender as defined hereinabove. However the at least one first chain extender and the at least one second chain extender are two chain extenders independent of each other.

In a preferred embodiment, the at least one second chain extender includes a diethylene glycol bischloroformate. In an embodiment, the part B of the mixture includes chain extender in range of 0 wt. % to 1 wt. %.

### Second Additive

In an embodiment, the part B of the mixture optionally includes at least one second additive.

The at least second additive is similar to the at least one first additive as defined herein above. However the at least one first additive and the at least one second additive are two additives independent of each other.

In a preferred embodiment, the at least one second additive includes a propylene carbonate, a benzoyl chloride, a methyldiphenylphosphine oxide, a diisodecyladipate, a trifluromethane sulfonic acid and a diol/a triol or combination thereof. In an embodiment, the part B of the mixture includes amine in range of 0 wt. % to 40.0 wt. %.

Method of Forming Polyurea Polymer from Mixture

In another aspect the presently claimed invention is directed to a method of forming the barrier with the polyurea polymer. The polyurea polymer is formed as a reaction product of a mixture. The method comprises:
a. providing part A and part B of the mixture; and
b. mixing the part A and part B.

In an embodiment, the part A and part B are optionally cooled before mixing such that reaction mixture is formed by slow reactivity.

In another embodiment the part A and part B are provided in a ratio of 1:1.

In another embodiment, part A and part B are mixed using a mixing blade at 1700 RPM.

In preferred embodiment, part A and part B are mixed and applied using a spray gun and proportioning unit.

### Method of Containment

In another aspect, the presently claimed invention is directed to a method containment of per- and polyfluoroalkyl substances (PFAS). The method comprises steps:
a. providing the substrate with at least one surface;
b. enclosing the at least one surface of the substrate with the barrier with polyurea polymer as described hereinabove;
c. optionally curing the polyurea polymer,
   wherein the barrier having the polyurea polymer enclosing the at least one surface restricts movement of the PFAS.

In preferred embodiment, the at least one surface of the substrate is enclosed with the barrier having polyurea polymer in step b. by applying the polyurea polymer.

In a more preferred embodiment, step b. of enclosing is performed by applying the polyurea polymer using a spray gun and proportioning unit.

In an embodiment, the enclosing by polyurea polymer in step b. is performed at a temperature in range from 100 F to 170F, preferably in range from 45° C. to 140° C., or in range from 45° C. to 130° C., or in range from 45° C. to 120° C., or in range from 45° C. to 110° C., in range from 45° C. to 100° C., more preferably in range from 120F to 150F.

In another embodiment, the polyurea polymer is applied in the step b. at specific volume ratio using plural component, high-pressure metering machine. The machine maintains the component in the mixture at a temperatures of at least 150° F. (66° C.) at a spray gun, as well as operating pressures up to 3000 psi. In a preferred embodiment, to form an impingement mix, airless spray gun with changeable spray tips is used such that optimization of the spray pattern is achieved.

In another embodiment, the polyurea polymer is applied in step b. without thinning.

In another embodiment, the polyurea polymer enclosing after step b. is cured.

In another embodiment, step of enclosing of step b. is repeated.

In another embodiment, enclosing in step b. is done by traditional spray application. The spray application is done in a manner such that the coating is uniform, continuous, and free of runs and sags.

In another embodiment, the method of containment comprises steps of at least:
a. providing a fabric as the substrate;
b. optionally pre-treating the fabric;
c. enclosing the fabric with the barrier having the polyurea polymer to form the reinforced fabric material;
d. optionally curing the reinforced fabric.

In a preferred embodiment, the reinforced fabric is used for containing construction waste material, PFAS contaminated products, and soil. In a more preferred embodiment, the reinforced fabric is in form of a waste bag or a dumpster.

In another embodiment, the method comprises steps of at least:
a. providing concrete as the substrate;
b. optionally pre-treating the concrete;
c. enclosing the concrete with the barrier having the polyurea polymer to form the coated concrete;
d. optionally curing the coated concrete.

In a preferred embodiment, the barrier having the polyurea polymer is coated on the concrete after pre-treatment of the concrete. In a more preferred embodiment, the pre-treatment comprises at least one step of:
a. removal of dust, all grease compounds, old coatings, loose concrete, other foreign matter on the at least one surface; wherein the removal is preferably done by vacuum cleaning, sand blasting, shot blasting, mechanical scarification, chemical treatment as per ASTM D 4259, or combination thereof.
b. applying the primer on the at least one surface, wherein the primer is an epoxy primer;
c. optionally, repairing cracks in the concrete by material compatible with the primer;
d. optionally, filling up bug holes; and
e. removal/grounding/smoothening of sharp or rough portions, protrusions on the surface of the concrete.

In another preferred embodiment, the concrete is cured for a minimum of 28 days at 70° F. (21° C.) and tested in accordance with ASTM D 4263—Standard Test Method for Indicating Moisture in Concrete prior to application. Moisture in the concrete is not allowed beyond 4% maximum.

In another preferred embodiment, the concrete is provided with vapour barriers or other means of waterproofing to prevent water intrusion, delamination or failure of the coating system. In a more preferred embodiment, the vapour barriers or other means of waterproofing are applied to concrete at or below grade. In another more preferred embodiment, vapour barrier is also applied to the unprotected side of the concrete when the enclosing is being applied to an interior surface at or below grade of the concrete.

In a furthermore preferred embodiment, to minimize outgassing from the porous surface of the concrete, application of primer and enclosing of the surface with the polyurea polymer are done as the air and surface temperatures are falling.

In another preferred embodiment, the coatings can be applied by spray or other application methods.

In another aspect, the presently claimed invention is directed to use of the containment system, or the method of containment of PFAS as described herein above to restrict movement of the PFAS in construction, containment of general PFAS contaminants, enclosing articles, preparation of bags, and preparation of containment units, prevention of PFAS contaminants in agricultural top soil, prevention of PFAS contaminants in water bodies, water tanks, food storage units, fuel storage units, human residential areas, houses, animal shelters, restricting PFAS contamination from a region with high PFAS concentration to a region with low PFAS concentration.

In an embodiment, the containment system and the method of containment is used for the purpose of sufficiently containing or preventing the migration of PFAS beyond the barrier. In a preferred embodiment, the substrate includes but are not limited to contaminated concrete pavement, contaminated concrete pipes, reinforced or un-reinforced fabrics or containers that hold PFAS contaminated materials.

In another embodiment, the claimed invention is directed to use of the containment system, or the method of containment of PFAS as described herein above for manufacture of an article for containment of PFAS or an article for prevention of PFAS contamination. The article includes but is not limited to bags, sheets, body wear, clothing, housing equipment, apparels, soil separation sheets, water containers, fluid containers, and the like.

### Advantages

The system for containment as described herein, in addition to providing a containment of PFAS movement from the surface of the substrate, the barrier having the polyurea coatings have the following advantages:
a. rapid curing such that minimum “down-time” is required for containment process;
b. low VOC content (near zero) for very low environmental impact;
c. improved abrasion resistance, tensile strength and adhesion of the final coating such that the substrates like concrete pavements, roads when applied with the applied with the barrier allows vehicle traffic, and also UV resistance for durability in outdoor areas.

### Method A

The amount of a PFAS contaminant in sample is determined by the method similar to EPA 537.1 (determination of selected per- and polyfluorinated alkyl substances in drinking water by solid phase extraction and/or liquid chromatography/tandem mass spectrometry), Version 1.0, dated November 2018, EPA Document #: EPA/600/R-18/352. Direct LC-MS-MS is utilized, and Solid phase extraction is used when necessary.

The presently claimed invention is illustrated in more detail by the following embodiments and combinations of embodiments which results from the corresponding dependency references and links:
I. A system for containment of per- and polyfluoroalkyl substances (PFAS), the system comprising:
   a. a substrate having at least one surface;
   b. a barrier enclosing the at least one surface of the substrate,
   c. wherein the barrier includes a polyurea polymer formed as a reaction product of an isocyanate, a polyol, an amine, a chain extender and at least one additive,
   d. wherein the barrier having the polyurea polymer enclosing the at least one surface restricts movement of the PFAS.
II. The system of embodiment I, wherein the substrate is selected from concrete, reinforced material, fabric, container, water tanks, pipe, cap cover, cap liner, aluminum, steel, blacktop, polyurethane foam, boat holds, geotextile fabrics, pipelines, decks, manholes, and fuel tanks.
III. The system of any one of embodiment I or II, wherein the substrate is contaminated with PFAS.
IV. The system of any one of embodiment I to III, wherein the amine is selected from polyetheramines, amine catalyst, amine chain extenders.
V. The system of any one of embodiment I to IV, wherein the polyol is selected from polyether polyols, polyester polyols, polyetherester polyols, polytetrahydrofuran, polyester diol, or a combination thereof.
VI. The system of any one of embodiment I to V, wherein the isocyanate is selected from isocyanate selected from 2,4-MDI, 4,4′-MDI (methylene diphenyl diisocyanate), a 50/50 blend of 2,4-MDI and 4,4-MDI, a carbodiimide modified isocyanate, carbodiimide modified diphenylmethane-4,4-diisocyanate (MDI), and ISOPHORONE Diisocyanate IPDI/aliphatic diisocyanate.
VII. The system of any one of embodiment I to VI, wherein the at least one additive is selected from a dye/pigment, an antioxidant, a mold release agent, a lubricant, a plasticiser, a hydrolysis stabilizer, an anti-blocking agent, a light stabilizer, a cross linker, a catalyst, a flame retardant, a rheology additive, a defoamer, a friction reducer, an antistatic agent, a surfactant, and other components, or combination thereof.
VIII. The system of any one of embodiment I to VII, wherein the barrier includes the polyurea polymer disposed completely or partially across the at least one surface of the substrate.
IX. The system of embodiment I to VIII, wherein the substrate is concrete.
X. The system of embodiment I to VIII, wherein the system is a reinforced fabric such that the substrate is a fabric and the surface of the fabric is coated with the barrier having polyurea polymer.
XI. A method containment of per- and polyfluoroalkyl substances (PFAS), the method comprising steps of at least:
   a. providing the substrate with at least one surface;
   b. enclosing the at least one surface of the substrate with the barrier with polyurea polymer of embodiment I to VIII;
   c. optionally curing the polyurea polymer,
   d. wherein the barrier having the polyurea polymer enclosing the at least one surface restricts movement of the PFAS.
XII. The method of embodiment XI, wherein the enclosing by polyurea polymer in step b. is performed at a temperature from 45° C. to 150° C.
XIII. The method of embodiment XI, wherein the method comprises:
   a. providing a fabric as the substrate;
   b. optionally pre-treating the fabric;
   c. enclosing the fabric with the barrier having the polyurea polymer to form the reinforced fabric material;
   d. optionally curing the reinforced fabric.
XIV. The method of embodiment IX, wherein the method comprises:
   a. providing concrete as the substrate;
   b. optionally pre-treating the concrete;
   c. enclosing the concrete with the barrier having the polyurea polymer to form the coated concrete;
   d. optionally curing the coated concrete.
XV. Use of the containment system of embodiment I to X or the method of embodiment XI to restrict movement of the PFAS in construction, containment of general contaminants, enclosing articles, preparation of bags, and preparation of containment units.
XVI. The system for containment of PFAS as described in embodiment I, wherein the barrier having polyurea polymer is formed as the reaction product of a mixture comprising:
   a. Part A, wherein the part A includes:
      i. at least one first amine;
      ii. optionally, at least one first chain extender;
      iii. optionally, a polyol composition comprising at least one first polyol; and
      iv. optionally, at least one first additive selected from a triol, a curing agent, a slow gelling agent, a catalyst, a molecular sieve, a colorant/a pigment, an antifoaming agent, an amine chain extender, a stabilizer, a coupling agent, an antioxidant, a mold release agent, a liquid rheology additive, and a thickening agent;
   and
   b. Part B, wherein the part B includes:
      i. an isocyanate mixture including at least one isocyanate;
      ii. optionally, at least one second polyol;
      iii. optionally, at least one second amine;
      iv. optionally, at least one second additive selected from a propylene carbonate, a benzoyl chloride, a methyldiphenylphosphine oxide, a diisodecyladipate, a trifluromethane sulfonic acid; a diol/a triol
wherein the amine is present in at least one of PART A or PART B or both, and
wherein the polyol is present in at least one of PART A or PART B or both.

### Examples

The presently claimed invention is illustrated by the non-restrictive examples which are as follows:

### Raw Materials

| | |
|---|---|
| Amine A | trifunctional primary amine/polyetheramine, Mol wt. 5000, CAS no. |
| | 64852-22-8 |
| Amine B | difunctional primary amine/polyetheramine, Mol wt. 2000 CAS No.: |
| | 9046-10-0, Density 0.948 g/cm³ |
| Amine C | Difunctional primary amine/polyetheramine, Mol wt. 430 |
| Amine D | Cycloaliphatic secondary amine curing agentModified Isophoronediamine, |
| | CAS No.: 93940-97-7, 3-((3-(((2-Cyanoethyl)amino)methyl)- |
| | 3,5,5-trimethylcyclohexyl)amino)propiononitrile |
| Amine E | Methyldiaminocyclohexane, cycloaliphatic amine curing agent CAS |
| | No.: 13897-55-7; CAS No.: 13897-56-8 |
| Amine F | 1-(3-(DIMETHYLAMINO)PROPYL)UREA |
| | Non-emissive amine catalyst, 730 Calculated OH Number, mgKOH/g |
| Antifoam | Compounded silicone foam control agent, Simethicone, Siloxanes and |
| | Silicones, di-Me, reaction products with silica, CAS No. 67762-90-7. |
| Antioxidant | Phenolic primary antioxidant CAS No. 125643-61-0 |
| Catalyst A | TEDA, CAS No.: 280-57-9, Triethylenediamine 33% sol. in dipropyl- |
| | eneglycol, Mol wt. 112.2 g/mol, Melting point −39 Deg C, Boiling point |
| | 173 Deg C |
| Catalyst B | Bismuth based Catalyst. Bismuth 7.8-8.2% Zinc 7.8-8.2% |
| Catalyst C | 1-(3-(DIMETHYLAMINO)PROPYL)UREA |
| | Non-emissive amine catalyst, 730 Calculated OH Number, mgKOH/g |
| Chain extender | Monoethylene glycol |
| A | |
| Chain extender | Diethylene glycol |
| B | |
| Chain extender | 1,4 Butanediol (BDO) |
| C | |
| Chain extender | DETDA (Diethyltoluenediamine), chain extender for polyurethane |
| D | elastomers, CAS No. 68479-98-1 |
| Diethylene | Diethylene glycol bischloroformate, CAS No. 106-75-2 |
| glycol | |
| bischloroformate | |
| Colorant/ | Dispersion of black pigment/soot (Colourant) in polyol carrier |
| pigment A | |
| Colorant/ | Dispersion of pigments in polyether polyol and additives |
| pigment B | |
| Colorant/ | rutile titanium dioxide pigment, TiO2 content - 95%, |
| pigment C | |
| Colorant/ | Dispersion of black pigment/soot in polyol carrier |
| pigment D | |
| Coupling Agent | Silane coupling agent, gamma-aminopropyltriethoxysilane, a versatile |
| | amino-functional coupling agent |
| Curing agent/ | 3,5-diethyltoluene-2,4-diamine, %75-81, 3,5-diethyltoluene-2,6- |
| Chain extender | diamine, %18-24, Dialkylated m-phenylenediamines, %0.5-3, |
| | Water, %<0.08 |
| Polyol F | EO capped polyether diol, 2000 MW), OH No. 56 mgKOH/g, Acid no. |
| | Max 0.03 mgKOH/g, |
| Iso A | 50/50 blend of 4,4′-MDI (methylene diphenyl diisocyanate) and 2,4- |
| | MDI, 33.5% NCO |
| Iso B | 4,4′-MDI (methylene diphenyl diisocyanate) (33.5% NCO, Mol wt. |
| | 250.25, CAS No. 101-68-8 |
| Iso C | Carbodiimide-Modified Isocyanate (carbodiimide-modified 4,4′- |
| | diphenylmethane diisocyanate), NCO Content 29.2 wt. %, Viscosity 40 |
| | cps@25 Deg C |
| Iso F | ISOPHORONE Diisocyanate IPDI/aliphatic diisocyanate, Mol wt.: |
| | 222.28, CAS No. 4098-71-9 |
| Liquid rheology | Solution of a modified urea, liquid rheological additive for solvent-borne |
| additive | and solvent-free systems |
| Mold Release | Silicone Surfactant, internal mold release Calculated OH# 38.7 Mg |
| Agent | KOH/g, |
| Molecular Sieve | MOLECULAR SIEVE 3A POWDER \| CAS No. 308080-99-1, |
| A | KnNa12-n[(AlO2)12(SiO2)12]•xH2O, Desiccating agent, |
| Molecular Sieve | Molecular Sieve in paste form with 3 Angstrom Paste |
| B | |
| Polyol A | Polyether polyol, propylene oxide capped, functionality 3, Avg OH |
| | Value 35, Mol Wt. (g/mole) 4800, Viscosity @25 Deg C 900, Acid no. |
| | 0.010, Na & K ppm 5, |
| Polyol B | Polyether polyol, propylene oxide capped to a propylene glycol |
| | nucleus, 53.4-58.8 mg KOG/g, Acid no. 0.015-0.025, Functionality: 2, |
| | Mol wt. 2000 |
| Polyol C | Ethylenediamine-initiated polyether polyol, Nominal functionality: 4, |
| | OH no. 800, Tetrol polymerized with ethylene and propylene oxides and |
| | has a mild catalytic nature. Mol Wt. 280. |
| Polyol D | Polyether polyol, propylene oxide capped to a propylene glycol nucleus, |
| | Hydroxyl no. 27.5-30.5 mgKOH/g, Acid no. 0.01, Functionality - 2, |
| | Mol Wt. 4000 |
| Slow Gelling | Aromatic diamine, di-functional, Curing agent/chain extender, |
| agent | Molecular Weight: 310, Equivalent Weight: Min. 153, Hydroxyl Number: 362, |
| | Density: 8.3 lb/US gallon, Specific. Gr. at 80 °F: 0.98-0.99 |
| Stabilizer | Mixture of bis(1,2,2,6,6-pentamethyl-4-piperidyl)sebacate and methyl |
| (Light/UV) | 1,2,2,6,6-pentamethyl-4-piperidyl sebacate, CAS No. 41556-26-7, |
| | 82919-37-7; Light Stabilizers/UV Absorbers > HALS, Hindered |
| | Amines |
| Thickening | Fumed silica/pyrogenic silica, CAS number: 112945-52-5 |
| agent | |
| Polyol E | Castor Oil \| Ricinoleic acid 85-95%, Oleic acid 2-6%, Linoleic acid |
| | 1-5%, α-Linolenic acid 0.5-1%, Stearic acid 0.5-1%, Palmitic acid |
| | 0.5-1% Dihydroxystearic acid 0.3-0.5%, Others |
| Triols/Sieve | Preblend (50/50) of Molecular Sieve in polyol in paste form with 3 |
| Blend | Angstrom Paste and b) High molecular weight trio having Hydroxyl no. |
| | 34.0-36.0 mgKOH/g, Acid no. 0.03, Functionality 3, Mol Wt. 4800) |

### Standard Method

| DIN 53240-1 | OH value |
|---|---|
| SSPC-PA-2 | Measuring Coating Thickness According To SSPC-PA 2 - |
| | Update 2015 |
| | Coating thickness shall be measured in accordance with |
| | SSPC: The Society for Protective Coatings Paint |
| | Application Standard No. 2 (SSPC-PA 2) with steps: |
| | Step 1: Instrument Calibration |
| | Step 2: Verification of Gage Accuracy on Certified |
| | Coated Standards or Certified Shims |
| | Step 3: Base Metal Reading Acquisition or Gage |
| | Adjustment (using certified or measured shims) |
| | Step 4: Measurement of Coating Thickness |
| | Step 5: Correction for Base Metal Reading (if acquired). |
| ASTM 4259 | Chemical removal of particles |
| ASTM 4263 | Standard Test Method for Indicating Moisture in Concrete |
| | prior to application. |

### General Process of Forming the PFAS Coating:

The barrier with polyurea polymer is prepared by mixing Part A and Part B in a ratio of 1:1. Formulation of each Part A and Part B in % wt. is provided as below.

TABLE

| Component | E1 | E2 | E3 | E4 | E5 | E6 | E7 | E8 |
|---|---|---|---|---|---|---|---|---|
| PART A | | | | | | | | |
| Polyol A/B/C/E | | 52 | 27.5 | | 37 | 37 | | |
| Curing agents | 26 | 9 | — | 38 | 14 | 14 | 12 | — |
| and/or Gelling | | | | | | | | |
| agent | | | | | | | | |
| Amine | 67 | 17 | 37.5 | 56.5 | 30 | 30 | 86.4 | 77.3 |
| (A/B/C/D/E/F | | | | | | | | |
| or combination) | | | | | | | | |
| Chain extender | 1 | 12 | 24.5 | — | 10 | 10 | — | — |
| A/B/C/D | | | | | | | | |
| Catalyst A/B | 1 | 3 | 1.25 | | 3 | 3 | 0.5 | |
| Molecular Sieve | 2 | 3 | | 0.5 | 4 | 4 | 1 | 0.5 |
| A, B, C. D | | | | | | | | |
| and/or E | | | | | | | | |
| Colorant/Pigment | 3 | 4 | 4 | 5 | 2 | 2 | | 20 |
| A, B, C and/or D | | | | | | | | |
| Additive package (1) | | | 5.25 | | | | 0.1 | 2.2 |
| Total | 100 | 100 | 100 | 100 | 100 | 100 | 100 | 100 |
| PART B | | | | | | | | |
| Iso A/B/C/D/E/ or | 51.48 | 68.97 | 62.4 | 59.13 | 68.97 | 75.18 | 36.2 | 46 |
| combination | | | | | | | | |
| Polyol A/B/C/D/F or | 48.52 | 31 | 26.79 | 39.13 | 31 | 24.82 | 63.75 | |
| combination | | | | | | | | |
| Amine (A/B/C/D/E/F) | | | | | | | | 49 |
| Additive Package (2) | 0.003 | 0.03 | 10.81 | 1.74 | 0.03 | 0.02 | 0.05 | 5 |
| | 100 | 100 | 100 | 100 | 100 | 100 | 100 | 100 |

(1) The Additive Package includes one or more of the following additional additives: Anti-foam, Stabilizer (Light/UV), Coupling Agent, Antioxidant, Liquid rheology additive, Sieve Blend and/or Thickening Agent
(2) The Additive Package includes one or more of the following additional additives: Diethylene glycol bischloroformate, Propylene Carbonate, or any combination thereof.

From the Examples E1 to E8 of the coating formulations, Example E2 was tested for performance as the barrier used to contain PFAS movement from a contaminated concrete substrate.

The substrate concrete was exposed to PFAS contaminants (PFAS contaminants included: ′6:2-FTS, PFHxA, PFHpA, PFOA, PFNA, PFOS). The concrete substrate was applied with the barrier as described in Example E2. The barrier as per E2 over the surface of the contaminated concrete substrate was checked for PFAS contaminants as per METHOD A. The leaching of the PFAS was checked periodically at Day 0, Day 1, Day 3, Week 1, Week 2, Week 4, Week 8, Week 12, and Month 9. The leaching of PFAS was checked on the barrier of thickness 1 mm and thickness 2 mm. PFAS containments were observed in contrast with uncoated contaminated surface. Values were determined in (ug/L).

TABLE
6:2- FTS

| | EXP | 1 mm | 2 mm | No Coat | Un Exp 1 mm |
|---|---|---|---|---|---|
| Day 0 | 7.79 | 4 | 4 | 4 | 4 |
| Day 1 | 111.06 | 4 | 4 | 4 | 4 |
| Day 3 | 116.21 | 4.09 | 4 | 4.06 | 4 |
| Week 1 | 136.69 | 4 | 4.12 | 4 | 4 |
| Week 2 | 149.13 | 4 | 5.35 | 4 | 4 |
| Week 4 | 150 | 4.68 | 4 | 4 | 4 |
| Week 8 | 122.34 | 5.1 | 6.8 | 4 | 4 |
| Week 12 | 111.84 | 8.68 | 11.81 | 4 | 4 |
| 9 Months | 72.66 | 5.5 | 4.75 | 4 | 4 |

TABLE
PFHxA

| | EXP | 1 mm | 2 mm | No Coat | Un Exp 1 mm |
|---|---|---|---|---|---|
| Day 0 | 3 | 3 | 3 | 3 | 3 |
| Day 1 | 4.93 | 3 | 3 | 3 | 3 |
| Day 3 | 3.07 | 3.25 | 3 | 11.32 | 3.26 |
| Week 1 | 3.46 | 3 | 16.81 | 3 | 3 |
| Week 2 | 3.09 | 3 | 3 | 3 | 3 |
| Week 4 | 24.25 | 3.76 | 3 | 3 | 3.15 |
| Week 8 | 4.31 | 3 | 3 | 3 | 3 |
| Week 12 | 5.44 | 3.85 | 4.43 | 3 | 3 |
| 9 Months | 3 | 3 | 3 | 3 | |

TABLE
PFHpA

| | EXP | 1 mm | 2 mm | No Coat | UnExp1 mm |
|---|---|---|---|---|---|
| Day 0 | 2 | 2 | 2 | 2 | 2 |
| Day 1 | 2.24 | 2 | 2 | 2 | 2 |
| Day 3 | 2 | 2 | 2 | 6.56 | 2.09 |
| Week 1 | 2 | 2 | 8.74 | 2 | 2 |
| Week 2 | 2 | 2 | 2 | 2 | 2 |
| Week 4 | 4.59 | 2.08 | 2 | 2 | 2 |
| Week 8 | 2 | 2 | 2 | 2 | 2 |
| Week 12 | 2 | 2 | 2 | 2 | 2 |
| 9 Months | 2 | 2 | 2 | 2 | 2 |

TABLE
PFOA

| | 1 mm | 2 mm | EXP | No Coat | UnExp1 mm |
|---|---|---|---|---|---|
| Day 0 | 2 | 2 | 2 | 2 | 2 |
| Day 1 | 2 | 2 | 4.22 | 2 | 2 |
| Day 3 | 2 | 2 | 3.93 | 2 | 2 |
| Week 1 | 2 | 2 | 4.22 | 2 | 2 |
| Week 2 | 2 | 2 | 4.21 | 2 | 2 |
| Week 4 | 2 | 2 | 5.11 | 2 | 2 |
| Week 8 | 2 | 2 | 3.08 | 2 | 2 |
| Week 12 | 2 | 2 | 3.13 | 2 | 2 |
| 9 Months | 2.16 | 2 | 3.67 | 2 | 2 |

TABLE
PFNA

| | 1 mm | 2 mm | EXP | No Coat | UnExp1 mm |
|---|---|---|---|---|---|
| Day 0 | 3 | 3 | 3 | 3.94 | 3 |
| Day 1 | 3 | 3 | 3.02 | 3 | 3 |
| Day 3 | 3 | 3 | 3.02 | 3 | 3 |
| Week 1 | 3 | 3 | 3.2 | 3 | 3 |
| Week 2 | 3 | 3 | 2.92 | 3 | 3 |
| Week 4 | 3 | 3 | 3 | 3 | 3 |
| Week 8 | 3 | 3 | 1.98 | 3 | 3 |
| Week 12 | 3 | 3 | 1.85 | 3 | 3 |
| 9 Months | 3 | 3 | 3 | 3 | 3 |

TABLE
PFOS

| | 1 mm | 2 mm | EXP | No Coat | UnExp1 mm |
|---|---|---|---|---|---|
| Day 0 | <2 | <2 | <2 | <2 | <2 |
| Day 1 | <2 | <2 | <2 | <2 | <2 |
| Day 3 | <2 | <2 | <2 | <2 | <2 |
| Week 1 | <2 | <2 | <2 | <2 | <2 |
| Week 2 | <2 | <2 | <2 | <2 | <2 |
| Week 4 | <2 | <2 | <2 | <2 | <2 |
| Week 8 | <2 | <2 | <2 | <2 | <2 |
| Week 12 | <2 | <2 | <2 | <2 | <2 |
| 9 Months | 3 | 3 | 3 | 5.5 | 3 |

As observed in the Tables above, the contaminated concrete surfaces when subjected to the PFAS contamination system having the barrier of the polyurea polymer E2 showed significant restriction/containment/limitation of movement of PFAS contaminant.

Properties of a barrier made of E2 in a system for containment of PFAS was also observed. E2 based barrier as shown below is associated with a significantly thin film thickness suitable for application on a variety of surfaces including uneven and rough surfaces like concrete. E2 based barriers is more importantly associated with a very quick drying time such that the containment systems can be applied in a short time duration and reduce down time of usage of the substrates (like concrete pavements that are subject to vehicular traffic, water pipelines supplying water to populated areas, etc.). More importantly, the VOC value being significantly low makes E2 based barrier safer for usage. In addition to the containment behaviour as described, the physical properties of E2 that are provided in below table. For testing the E2 was spray applied.

| | | Film | Dry | Tensile | VOC |
|---|---|---|---|---|---|
| | Additional properties | Thickness | time | Strength | (g/L) |
| E2 | Tear Resistance - 304 pli, | 40-60 mils | 5 secs | 1800 PSI, | 0.257 |
| | H2O Vapor Transmission - 0.1 | | tack | 115% | g/L |
| | perm/inch, | | free, | elongation - | |
| | Compressive Strength - 1064 PSI | | 24 hrs | ASTM | |
| | ASTM D 2240, | | full | D1623 | |
| | Abrasion Resistance (Taber): 150 | | | | |
| | mg, | | | | |
| | CS 17, 1000 g, 1000 rev, Hardness 45 | | | | |
| | Shore D, | | | | |
| | Adhesion: 540 PSI | | | | |
| | Concrete failure, 1850 PSI to steel | | | | |

1. A system for containment of per- and polyfluoroalkyl substances (PFAS), the system comprising:
a. a substrate having at least one surface;
b. a barrier enclosing the at least one surface of the substrate,
wherein the barrier includes a polyurea polymer formed as a reaction product of at least one isocyanate, at least one polyol, at least one amine, at least one chain extender and at least one additive,
wherein the barrier having the polyurea polymer enclosing the at least one surface restricts movement of the PFAS.

2. The system of claim 1, wherein the substrate is selected from the group consisting of concrete, reinforced material, fabric, container, water tanks, pipe, cap cover, cap liner, sheets, aluminum, steel, blacktop, polyurethane foam, boat holds, geotextile fabrics, pipelines, decks, manholes, cylinder, uneven surface, soil/dirt, and fuel tanks.

3. The system of claim 1, wherein the substrate is contaminated with PFAS.

4. The system of claim 1, wherein the polyol is selected from the group consisting of polyether polyols, polyester polyols, polyetherester polyols, polytetrahydrofuran, polyester diol, and any combination thereof.

5. The system of claim 1, wherein the isocyanate is selected from the group consisting of 2,4-MDI, 4,4′-MDI (methylene diphenyl diisocyanate), a 50/50 blend of 2,4-MDI and 4,4-MDI, a carbodiimide modified isocyanate, carbodiimide modified diphenylmethane-4,4-diisocyanate (MDI), and ISOPHORONE Diisocyanate IPDI/aliphatic diisocyanate.

6. The system of claim 1, wherein the at least one additive is selected from the group consisting of a dye/pigment, an antioxidant, a mold release agent, a lubricant, a plasticiser, a hydrolysis stabilizer, an anti-blocking agent, a light stabilizer, a cross linker, a catalyst, a flame retardant, a rheology additive, a defoamer, a friction reducer, an antistatic agent, a surfactant, other components, and any combination thereof.

7. The system of claim 1, wherein the barrier including the polyurea polymer is disposed completely or partially across the at least one surface of the substrate.

8. The system of claim 1, wherein the substrate is concrete.

9. The system of claim 1, wherein the system is a reinforced fabric such that the substrate is a fabric and the surface of the fabric is coated with the barrier comprising the polyurea polymer.

10. A method of containment of per- and polyfluoroalkyl substances (PFAS), the method comprising at least:
a. providing a substrate with at least one surface;
b. enclosing the at least one surface of the substrate with a barrier comprising polyurea polymer, thereby forming the system of claim 1;
c. optionally curing the polyurea polymer,
wherein the barrier having the polyurea polymer enclosing the at least one surface contains movement of the PFAS from the surface.

11. The method of claim 10, wherein the enclosing of the at least one surface by the barrier comprising the polyurea polymer in b. is performed at a temperature from 45° C. to 150° C.

12. The method of claim 10, wherein the method comprises:
providing a fabric as the substrate;
optionally pre-treating the fabric;
enclosing the fabric with the barrier having the polyurea polymer to form a reinforced fabric material;
optionally curing the reinforced fabric material.

13. The method of claim 10, wherein the method comprises:
providing concrete as the substrate;
optionally pre-treating the concrete;
enclosing the concrete with the barrier having the polyurea polymer to form a coated concrete;
optionally curing the coated concrete.

14. A method of restricting movement of per- and polyfluoroalkyl substances (PFAS) in construction, containment of general contaminants, enclosing articles, preparation of bags, and/or preparation of containment units, the method comprising:
restricting movement of the PFAS with the system of claim 1.

15. The system for containment of PFAS as claimed in claim 1, wherein the barrier having polyurea polymer is formed as the reaction product of a mixture comprising:
a. Part A, wherein the part A includes:
i. at least one first amine;
ii. optionally, at least one first chain extender;
iii. optionally, a polyol composition comprising at least one first polyol; and
iv. optionally, at least one first additive selected from the group consisting of a triol, a curing agent, a slow gelling agent, a catalyst, a molecular sieve, a colorant/a pigment, an antifoaming agent, an amine chain extender, a stabilizer, a coupling agent, an antioxidant, a mold release agent, a liquid rheology additive, and a thickening agent;
and
b. Part B, wherein the part B includes:
i. an isocyanate mixture including at least one isocyanate;
ii optionally, at least one second polyol;
iii. optionally, at least one second amine;
iv. optionally, at least one second additive selected from the group consisting of a propylene carbonate, a benzoyl chloride, a methyldiphenylphosphine oxide, a diisodecyladipate, a trifluromethane sulfonic acid, and a diol/a triol;
wherein the amine is present in PART A or PART B or both,
wherein the polyol is present in PART A or PART B or both.
